(19) United States
(12) Patent Application Publication
(10) Pub. No.: US 2014/0343984 A1
(43) Pub. Date: Nov. 20, 2014

(54) SPATIAL CROWDSOURCING WITH TRUSTWORTHY QUERY ANSWERING

(71) Applicants: Cyrus Shahabi, Irvine, CA (US); Leyla Kazemi, Bellevue, WA (US)

(72) Inventors: Cyrus Shahabi, Irvine, CA (US); Leyla Kazemi, Bellevue, WA (US)

(73) Assignee: UNIVERSITY OF SOUTHERN CALIFORNIA, Los Angeles, CA (US)

(21) Appl. No.: 14/213,610

(22) Filed: Mar. 14, 2014

Related U.S. Application Data
(60) Provisional application No. 61/785,510, filed on Mar. 14, 2013.
(60) Provisional application No. 61/829,617, filed on May 31, 2013.

(51) Int. Cl. G06Q 10/06; G06F 17/18

(52) U.S. Cl. CPC G06Q 10/06311; G06F 17/18
USPC 705/7.13

(57) ABSTRACT

Spatial crowdsourcing systems and methods assign spatial tasks to be performed by human workers. The systems and methods can verify the validity of the results provided by workers. Every worker can have a reputation score stating the probability that the worker performs a task correctly. Every spatial task can have a confidence threshold determining the minimum quality of the accepted level of its result. To satisfy this threshold, a task may be assigned redundantly to multiple workers. A reputation score can be associated to every worker, which represents the probability that a worker performs a task correctly. A task may be assigned to a subset of workers whose aggregate reputation score satisfies the confidence of the task.

### CROSS-REFERENCE TO RELATED APPLICATIONS

This application is based upon and claims priority to U.S. provisional patent application 61/785,510, entitled “GeoCrowd—Next Generation of Data Collection: Harnessing the Power of Crowd for On-Demand Location Scouting,” filed Mar. 14, 2013, attorney docket number 028080-0858.

This application is further based upon and claims priority to U.S. provisional patent application 61/829,617, entitled “GeoTruCrowd: Trustworthy Query Answering with Spatial Crowdsourcing,” filed May 31, 2013, attorney docket number 028080-0909.

### STATEMENT REGARDING FEDERALLY SPONSORED RESEARCH

This invention was made with government support under Grant No. CNS-0831505, awarded by the National Science Foundation (NSF). The government has certain rights in the invention.

The entire content of each of these applications and patents is incorporated herein by reference.

### BACKGROUND

1. Technical Field

This disclosure relates to collection of data from people assigned spatial tasks related to a location.

2. Description of Related Art

With recent ubiquity of mobile devices, technology advances of mobile phones, and wireless network bandwidth improvements, every user of a mobile phone can now act as a multimodal sensor collecting various types of data instantaneously (e.g., picture, video, audio, location, time). This opens up a new mechanism for efficient and scalable data collection, called spatial crowdsourcing. With spatial crowdsourcing, the goal is to crowdsource a set of spatial tasks (i.e., tasks related to a location) to a set of workers, which requires the workers to perform the spatial tasks by physically traveling to those locations. For example, consider a scenario, in which a requester (e.g., a news agency server) is interested in collecting pictures and videos of anti-government riots from various locations of a city. With spatial crowdsourcing, the requester, instead of traveling to the location of each event issues his query to a spatial crowdsourcing server (or SC-server). Subsequently, the SC-server crowdsources the query among the available workers in proximity of the events. Once the workers complete their tasks in their vicinity, the results are sent back to the requester.

However, a major impediment to the practicality and success of any spatial crowdsourcing system is the issue of trust. The reason is that the tasks performed by workers cannot always be trusted, because the motivation of the workers is not always clear. For example, in the same scenario, malicious users may also upload incorrect pictures and videos which paint a totally different image of what is occurring. Some skeptics of crowdsourcing go as far as calling it a garbage-in-garbage-out system due to the issue of trust.

While crowdsourcing has largely been used by both research communities (e.g., database) and industry (e.g., Amazon's Mechanical Turk), only a few work have studied spatial crowdsourcing. Moreover, most existing work on spatial crowdsourcing focus on a particular class of spatial crowdsourcing, called participatory sensing. With participatory sensing, the goal is to exploit the mobile users for a given campaign by leveraging their sensor-equipped mobile devices to collect and share data. Some real-world examples of participatory sensing projects include, which use mobile sensors/smart phones mounted on vehicles to collect information about traffic, WiFi access points on the route and road condition. However, most of these work solve the trust issue by incorporating a trusted software/hardware module in the user's mobile device While this protects the sensed data from malicious software manipulation before sending it to the server, it does not protect the data from users who either intentionally (i.e., malicious users) or unintentionally (e.g., making mistakes) perform the tasks incorrectly.

### SUMMARY

Enabled by mobile devices, a class of applications, called spatial crowdsourcing, is emerging, which assigns spatial tasks (i.e., tasks related to a location) to be performed by human workers. One challenge with spatial crowdsourcing is how to verify the validity of the results provided by workers. Towards this end, it can be assumed that every worker has a reputation score stating the probability that the worker performs a task correctly. Moreover, every spatial task has a confidence threshold determining the minimum quality of the accepted level of its result. To satisfy this threshold, a task may be assigned redundantly to multiple workers. The problem is to maximize the number of spatial tasks assigned to a set of workers while satisfying the confidence levels of those tasks. Subsequently, alternative approaches are proposed to address this problem. Experiments on real-world and synthetic data validate the applicability and compare the performance of the approaches.

The present disclosure addresses the issue of trust in one class of spatial crowdsourcing, known as server assigned, in which a set of workers send their locations to an SC-server, and then the SC-server assigns to every worker his nearby tasks. Subsequently, a reputation score can be associated to every worker, which represents the probability that a worker performs a task correctly. A definition of a confidence level is provided, given by the requester of each spatial task, which states that the answer to the given spatial task is only acceptable if its confidence is higher than the given threshold. Consequently, the SC-server, who receives the location of the workers assigns to every worker his nearby tasks only if his reputation satisfies the confidence of a given task. However, it is possible that a spatial task cannot be assigned to any individual worker because its confidence is not satisfied by any of the worker's reputation score. In this case, a task may be assigned to a subset of workers whose aggregate reputation score satisfies the confidence of the task. A voting mechanism can be utilized to aggregate the reputation scores of the workers by computing the probability that the majority of workers perform the task correctly. This is based on the idea of the wisdom of crowds that the majority of the workers are trusted.

With server assigned spatial crowdsourcing, the main optimization goal is to maximize the overall task assignment. Consequently, the problem turns into maximizing the number of assigned tasks while satisfying the confidence of every task. This problem can be referred to as a Maximum Correct Task Assignment (or, “MCTA”) problem. Proof is provided that the MCTA problem is NP-hard by reduction from 3D matching problem, which renders the optimal algorithms impractical. Consequently, three approximation algorithms are proposed to solve the MCTA problem.

The first proposed solution, named Greedy (GR), is an adaptation of a greedy solution to the 3D-matching problem. The second approach, namely Local Optimization (LO), tries to improve the Greedy approach by performing some local optimization. Finally, the third approach, referred to as Heuristic-based Greedy (HGR) applies some heuristics to efficiently improve the approximation and reduce the travel cost. Extensive experiments on both real and synthetic data show that the LO approach is not (currently) readily applicable to the real-world applications due to its significantly high CPU cost. Meanwhile, the GR approach, while fast enough for real-world applications (250 times faster than LO on average), its performance in terms of number of assigned tasks is much lower than that of LO (40% worse than LO on average). Instead, the HGR approach represents the best of the both worlds: it is as fast as the GR approach and meanwhile its performance in terms of number of assigned tasks is similar to that of the LO approach. On top of that, HGR outperforms LO in terms of workers' travel cost by a factor of 2 on average. Hence, a conclusion can be made that the disclosed heuristics are effective enough to improve the performance of a greedy algorithm to become comparable to a locally optimal algorithm without incurring the extra execution time penalty.

In the rest of the present disclosure, a discussion is given of a set of preliminaries in the context of spatial crowdsourcing, and a formal definition of the MCTA problem is given. The complexity analysis of the MCTA problem is also provided. Thereafter, an explanation is provided for assignment solutions, followed by experimental results. These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of a trustworthy spatial crowdsourcing framework used for a GeoTruCrowd embodiment.

FIG. 2 illustrates an example of a trustworthy spatial crowdsourcing system with a set of spatial tasks.

FIGS. 3A-3F include graphs 3A, 3B, 3C, 3D, 3E, and 3F, which illustrate scalability of various GeoTruCrowd approaches varying the number of workers whose spatial regions contain a given spatial task.

FIGS. 4A-4C include graphs4A, 4B, and 4C, which illustrate results of experiments on real data, in which the average number of WIT is 4.

FIGS. 5A-5B illustrate the effect of tasks per worker as applied to synthetic data.

FIGS. 6A-6C illustrate the performance of multiple approaches measured with respect to increasing the average value of maxi.

FIG. 7 illustrates an example of an overall structure of the MediaQ framework with its sub-components.

FIG. 8 illustrates a 2D Field-of-View (FOV) model for a MediaQ example.

FIGS. 9A-9B illustrate two screenshots of the media collection with metadata module in a MediaQ mobile app for Android-based (top) and iOS-based (bottom) smartphones

FIGS. 10A-10B depict two graphs showing the cumulative distribution function of average error distances for two different algorithms: 10A based on Kalman filtering, and 10B based on linear-least-squares regression.

FIG. 11 illustrates an example of the process flow in the tagging module of an exemplary MediaQ system.

FIG. 12 illustrates an instance problem of the Maximum Task Assignment (MTA).

FIG. 13 illustrates an example of a reduction of MTA to the maximum flow problem.

FIG. 14 illustrates another example of a GeoCrowd system architecture.

FIGS. 15A-B illustrates two cases of FOV's results for range queries in views (a)-(b).

FIG. 16 illustrates a query result representation through video segments.

FIG. 17 illustrates an example of the design of a MediaQ mobile app for use with a server side component such a GeoCrowd or GeoTruCrowd-based server.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described. In this section, a set of terminologies that will be used in the present disclosure is introduced.

### Terminologies

A spatial task is defined as a task related to a location. Consequently, a spatial task can formally be defined as follows.

DEFINITION 1 (SPATIAL TASK). A spatial task t is represented as a tuple of form <l, d> which is a task with description d, that is to be performed in location l, where l is a point in the 2D space.

Note that the spatial task t can be performed by a human only if the human is physically located at location l. An example of a spatial task's description is as follows: Given an image, is it the image of a particular building?

With spatial crowdsourcing, the general assumption is that every spatial task is performed correctly. However, in many scenarios a worker may intentionally (e.g., in the case of malicious users) or unintentionally (e.g., in the case of making mistakes) provide a wrong answer to a given query. Therefore, a confidence is defined level for every spatial task, which states that the answer to the given spatial task is only acceptable if its confidence is higher than a given threshold. A definition is provided here for the notions of a-confidence and probabilistic spatial crowdsourced query, respectively.

DEFINITION 2 (α-CONFIDENT SPATIAL TASK). A spatial task t is a-confident, if the probability of the task t being performed correctly is at least a.

DEFINITION 3 [Probabilistic Spatial Crowdsourced Query] A probabilistic spatial crowdsourced query (or PSC-Query) of form (<t₁, α₁>, <t₂, α₂>, . . . is a query consisting of a set of tuples of form [symbol] tᵢ, αᵢ [symbol] issued by a requester, where every spatial task tᵢ is to be crowdsourced with at least αᵢ-confidence.

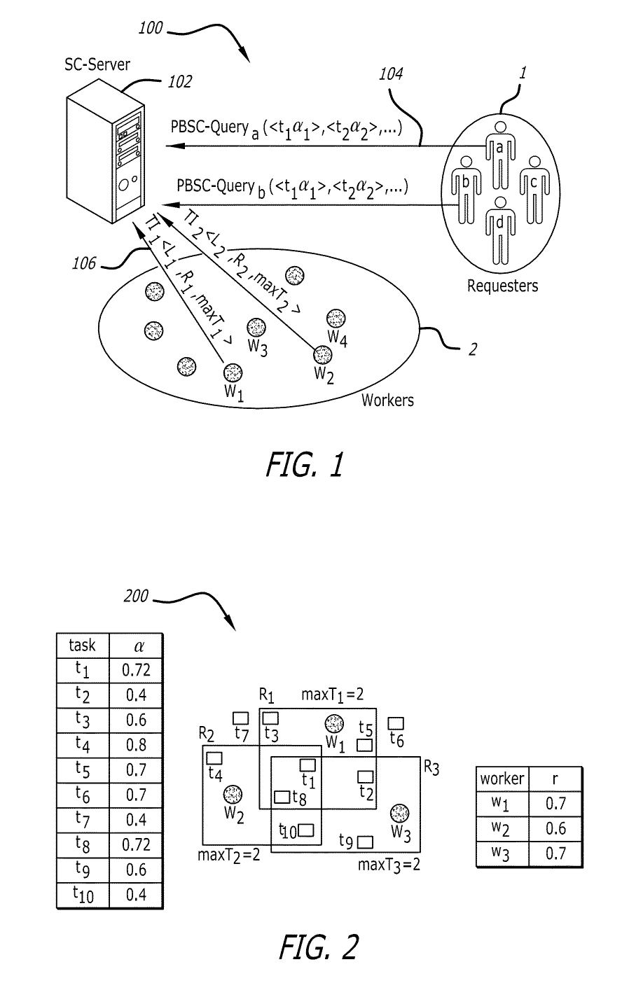

After receiving the PSC-queries from all the requesters, the spatial crowdsourcing server (or SC-server) assigns the spatial tasks of these PSC-queries to the available workers, while satisfying the confidence probability of every spatial task. This is referred to as a trustworthy spatial crowdsourcing framework (as shown in FIG. 1).

In the present disclosure, a carrier of a mobile device who volunteers to perform spatial tasks is referred to as a worker, w. The focus here is on self-incentivized spatial crowdsourcing, in which people are self-incentivized to perform tasks voluntarily without expecting a certain reward. Moreover, every worker is associated with a reputation score r (0≦r≦1), which gives the probability that the worker performs a task correctly. Consequently, the higher the reputation score, the more the chance that the worker performs a given task correctly. A reputation value or score of a particular worker can be obtained from mining the answers returned by the worker. The reputation scores can be stored and maintained at the SC-server. Once a worker is ready to perform tasks, he or she sends a task inquiry (or, query) to the SC-server (see FIG. 1). Of course, for the case where a reputation score of an available worker or workers is 1 or the probability that the task will be performed correctly is 1.0 (which can occur when the given threshold approaches 0 or when all available workers have a reputation score of 1), then the MCTA reduces to a MTA as described in the above-referenced U.S. provisional patent application 61/785,510, entitled “GeoCrowd—Next Generation of Data Collection: Harnessing the Power of Crowd for On-Demand Location Scouting.” A task inquiry is defined infra.

DEFINITION 4 (Task Inquiry or T1). Task inquiry is a request that a worker ω sends to the SC-server, when ready to work. The inquiry includes the location of w, L, along with two constraints: a spatial region R, and the maximum number of acceptable tasks maxT, where R is the area in which the worker accepts spatial tasks, and maxT is the maximum number of tasks that the worker is willing to perform.

Once the workers send their task inquiries, the SC-server can assign to every worker a set of tasks, while satisfying both the constraints of the workers and the confidence probability of the tasks. In the present disclosure, without loss of generality, it is assumed that all spatial tasks have the same level of difficulty. This means that the probability of a task being performed correctly (i.e., its confidence) is only influenced by the reputation of the worker who performs it. Of course, this may not always be the case, and the probability of a task being performed correctly may in fact be influenced by the difficulty of the particular task.

FIG. 2 illustrates an example of a trustworthy spatial crowdsourcing system 200 with a set of spatial tasks T={t₁, . . . , t₁₀} and a set of workers W={w₁, w₂, w₃}. The confidence probabilities of the tasks and the reputation scores of the workers are shown in two different tables. An example of an assignment is to assign t₂ and t₃ to w₁, since both tasks are inside the spatial region of w₁ (i.e., R₁. Moreover, the reputation score of w₁ satisfies the confidence probability of both t₂ and t₃ (i.e., r₁>α, r₁>α₃). Finally, the maximum number of acceptable tasks for w₁ is 2 (i.e., maxT₁=2).

### Reputation Scheme

The problem of crowdsourcing a set of spatial tasks to a set of workers has recently been studied, in which the goal is to maximize the number of spatial tasks assigned to workers, while satisfying the constraints of the workers. However, unlike the case where the assumption is that all workers are trusted, and therefore, every task can be assigned to only one worker, with PSC-query one may also take into account the confidence probability of the tasks. Thus, a task may be needed to be assigned to more than one worker. Consider the example of FIG. 2, in which t₁ is located inside the spatial regions of all the three workers. Here, t₁ cannot be assigned to any of the individual workers, because its confidence probability is not satisfied by any of them. Instead, it may be possible to assign t₁ to a number of workers simultaneously, where the aggregation of the workers' reputation scores satisfies α₁. Consequently, by assigning multiple workers to a task, two issues arise: 1) how to aggregate the different results provided by a group of workers for a given task, and 2) how to aggregate the reputation scores of the workers to check if the required confidence is satisfied. In the following, two related issues are examined.

With spatial crowdsourcing applications, one of the major challenges is how to aggregate the results provided by different workers. Note that different spatial tasks may support different modalities of results (e.g., binary/numerical value, text, photo). In the present disclosure, for simplicity it may be assumed that the result of a spatial task is in the form of a binary value (0/1). However, this can be generalized to any data modality, for example by representing any modality of data as a binary value. One of the well-known mechanisms to make a single decision based on the results provided by a group of workers is majority voting, which accepts the result supported by the majority of workers. This intuition is based on the idea of the wisdom of crowds, i.e., that the majority of the workers are trusted. In the present disclosure, majority voting is used for any decision process when multiple workers perform a single task simultaneously; other suitable voting/selection schemes may also be used within the scope of the present disclosure.

Next, in order to aggregate the reputation score of the workers, it is advantageous to compute the probability that the majority of workers perform the task correctly may be computed/calculated. Thus, the Aggregate Reputation Score may be defined.

DEFINITION 5 (AGGREGATE REPUTATION SCORE (ARS)). Given a spatial task tεT, the aggregate reputation score of the set Q C W is the probability that at least

$$\frac{Q}{2} + 1$$

number of the workers will perform the task t correctly:

$$A R S ( Q ) = {\sum }_{k = \frac{\vert Q \vert}{2} + 1}^{\vert Q \vert} {\sum }_{A ⋐ Fk} {\prod }_{{w}_{2} ∈ A} {r}_{j} {\prod }_{{w}_{3} ∉ A} ( 1 - {r}_{j} )$$

where Fₖ is all the subsets of Q with size k, and rⱼ is the reputation of the worker wⱼ.

Consider t₁ in the example of FIG. 2.

As FIG. 2 shows, t₁ is located inside the spatial regions of all the three workers w₁, w₂, and w₃. In order to compute the aggregate reputation score for the set Q={w₂, w₃}, the probability that the majority (i.e., at least two) of the workers perform the task correctly can be calculated. Thus, the aggregate reputation score of the three workers can be calculated/determined as follows:

ARS(Q)(0.7×0.6×0.7)+(0.7×0.4×0.7)+(0.7×0.6×0.3×2)=0.74

Consequently, by aggregating the reputation score of the three workers, t₁ can be performed by assigning it to all the three workers simultaneously, since α₁<74%.

TABLE 1
Illustrating the potential match sets for the spatial tasks of FIG. 2
Problem Definition

| Task | Potential Match Set |
|---|---|
| t₁ | {(t₁, [symbol] w₁w₂w₃ [symbol] )} |
| t₂ | {(t₂, [symbol] w₁w₃ [symbol] ), (t₂ [symbol] w₁ [symbol] ), (t₂, [symbol] w₃ [symbol] )} |
| t₃ | {(t₃, [symbol] w₁ [symbol] )} |
| t₄ | { } |
| t₅ | {(t₅, [symbol] w₁ [symbol] )} |
| t₆ | { } |
| t₇ | { } |
| t₈ | {(t₈, [symbol] w₁w₂w₃ [symbol] )} |
| t₉ | {(t₉, [symbol] w₃ [symbol] )} |
| t₁₀ | {(t₁₀, [symbol] w₂w₃ [symbol] ), (t₁₀ [symbol] w₂ [symbol] ), (t₁₀, [symbol] w₃ [symbol] )} |

In this section, the notions of a correct match and a potential match set are defined. Thereafter, a formally problem definition is given.

DEFINITION 6 (CORRECT MATCH). Given a task tεT and a set of workers W, the set CCW is referred to as a correct match for the task t, if t is located inside the spatial region of every worker ωεC, and the aggregate reputation score of the workers in C satisfies the confidence probability oft (i.e., ARS(C)≧α). The set C is denoted by <wᵢwⱼ . . . >. Moreover, a correct match between a given task and a set C of workers can be represented by (t,<wᵢwⱼ . . . >) (or (t,C)).

An example of a correct match in FIG. 2 is (t₁,<w₁,w₂,w₃>), since all the three workers have t₁ in their spatial regions, and ARS({w₁,w₂,w₃})>α₁.

DEFINITION 7 (POTENTIAL MATCH SET). Given a task tᵢεT and a set of workers W, let P(W) be the power set of the set W. The set M₁CP(W) may be referred to as the potential match set for tᵢ if Mᵢ contains all the correct matches for tᵢ.

Table 1 depicts the potential match sets for all the spatial tasks of FIG. 2. For example, the potential match set for t₂ is M₂{(t₂, [symbol] w₁ [symbol] ), (t₂, [symbol] w₃ [symbol] ), (t₂, [symbol] w₁w₃ [symbol] )}, since t₂ is only located inside the spatial regions of w₁ and w₃. Moreover, the aggregate reputation score of every CεM₂ satisfies the confidence probability of t₂ (i.e., r₁>α₂, r₃>α₂, and ARS({w₁,w₃})>α₂).

With trustworthy spatial crowdsourcing, a focus is to maximize the number of assigned tasks while satisfying both the constraints of the workers as well as the confidence probability of the spatial tasks. A formal definition of the problem is provided below.

DEFINITION 8 (PROBLEM DEFINITION). Given a set of workers W={w₁, w₃, . . . } and a set of spatial tasks T={t₁, t₂, . . . }, let M=Uᵢ₌₁^{|T|} Mᵢ be the union of the potential match sets for all spatial tasks, where every correct match in M is of form (tᵢ, <wⱼwₖ . . . >). The maximum correct task assignment (or MCTA) problem is to maximize the number of assigned tasks by selecting a subset of the correct matches, in which every spatial task tᵢ is assigned to at most one correct match in M, while satisfying the workers' constraints.

### Complexity Analysis

In order to solve the MCTA problem, an exhaustive approach is to perform a brute-force search by computing all the subsets of the set M (i.e., 2^{|M|}) which satisfy the constraints of the workers, and then choose the one with maximum size. However, in real-world the set M is large, which renders the exhaustive approach impractical due to its computationally expensive cost. In this section, a proof is provided showing that the maximum correct task assignment is an NP-hard problem by reduction from maximum 3-dimensional matching (M3M) problem, which is also an NP-hard problem. The M3M problem can be formalized as follows:

DEFINITION 9 (M3M PROBLEM). Let X, Y, and Z be finite, disjoint sets, and let T be a subset of X×Y×Z. That is, for every triple (x, y, z)εT, xεX, yεY, and zεZ. M⊂T can be considered to be a 3-dimensional matching if for any two distinct triples (x₁, y₁, z₁) E M and (x₂, y₂, z₂)εM, the two triples do not contradict (i.e., x₁≠x₂, y₁≠y₂, and z₁≠z₂). Thus, the M3M problem is to find a 3-dimensional matching M⊂T that maximizes |M|.

In order to prove that the MCTA₁ problem is NP-hard, a proof is first provided for the contention or hypothesis that the MCTA₁ problem is NP-hard; MCTA1 can be defined as a special instance of MCTA problem in which the maximum number of acceptable tasks (i.e., maxT) for every worker is one. Thereafter, it can readily be concluded that the MCTA problem is NP-hard. The following lemma proves that MCTA₁ is NP-hard.

LEMMA 1. The MCTA₁ Problem is NP-Hard.

PROOF. The lemma is proved by providing a polynomial reduction from the M3M problem. Towards that end, given an instance of the M3M problem, denoted by lₘ, it can be proved that there exists an instance of the MCTA₁ problem, denoted by lₐ, such that the solution to lₐ can be converted to the solution of lₘ in polynomial time. Consider a given lₘ, in which each set X, Y, and Z has n elements. Also, let T be a subset of X×Y×Z. To solve lₘ, a set M⊂T, is selected in which M is the largest 3D matching. Correspondingly, to solve lₐ, A⊂Uᵢ₌₁^{|T|}Mᵢ can be selected with maximum cardinality, which no two matches in A should overlap.

Therefore, the following mapping from lₘ components to lₐ components is proposed to reduce lₘ to lₐ. For every element in X, a spatial task can be created. Thereafter, for every element in Y and Z, a worker can be created. That is, a total of n spatial tasks and 2n workers can be created. Every task tᵢ has a potential match set Mᵢ, which is the set of all possible correct matches. Moreover, every correct match Uᵢ₌₁^{|T|}Mᵢ is a triple of form (tₓ, <w_{y}w_{z}>), where O<x≦n, O<y≦n, and n<z≦2n. Consequently, to solve lₐ, one needs to find a set A⊂M, in which A is the largest 3D matching. That is, for every two matches in A (tₓ_{₁}, [symbol] wₓ_{₁}, w_{z}_{₁} [symbol] ) and (tₓ_{₂}, [symbol] wₓ_{₂}, w_{z}_{₂} [symbol] ), tₓ_{₁}≠tₓ_{₂}w_{y}_{₁}≠w_{y}_{₂}, and w_{z}_{₁}≠w_{z}_{₂}. It is easy to observe that if the answer to l_{α} is the set A, the answer to lₘ will be the set M with maximum cardinality. This completes the proof.

The following theorem follows from Lemma 1:

THEOREM 1. The MCTA problem is NP-hard.

PROOF. The proof is provided by restriction from MCTA₁. MCTA₁ is a special instance of MCTA and is NP-hard based on Lemma 1. Therefore, MCTA is also NP-hard.

### Assignment Protocol

Based on Theorem 1, the MCTA problem is NP-hard, which renders the optimal algorithms impractical. Consequently, approximation algorithms that solve the 3D-matching problem can be considered to find a solution to the MCTA problem. In the following, three solutions to this problem are proposed; other solutions may be utilized within the scope of the present disclosure.

### Greedy (GR) Approach

One of the well-known approaches for solving the 3D-matching is a greedy algorithm which iteratively expands the matching set until no more expansion is possible. Correspondingly, to solve the MCTA problem, one can iteratively assign a task to one of its correct matches, until no more assignment is possible. Note that with the MCTA problem, the maximum number of acceptable tasks for every worker may not necessarily be one. Consequently, this can be addressed by transforming every worker with maxT capacity into maxT workers with capacity of 1. This allows a worker to be assigned to at most maxT number of tasks. Moreover, unlike the 3D-matching problem where every match is in the form of a triple, with the MCTA problem every correct match may contain any number of workers (i.e., from 1 to |W|).

Details of the GR approach are exampled with the example of FIG. 2. The algorithm starts by iterating through every correct match in the set M, which is the union of the potential match sets for all spatial tasks, and adds the correct match to the result set A if it does not contradict with any of the already added correct matches. A correct match (t₁, C) can be considered to contradict another correct match (tᵢ , C′) in A if either of these two cases occur: 1) the task has already been assigned (i.e., tᵢ=t_{i′}), or 2) for any worker in the set C, the worker has already used all his capacity. That is, the worker has been assigned maxT number of times. Table 2 depicts the status of the set A for the example of FIG. 2 at every step. It can be seen that at every step the most recently added correct match is shown in bold. According to Table 2, in the first step the algorithm assigns t₁ to [symbol] w₁w₂w₃ [symbol] . Thereafter, the algorithm assigns t₂ to [symbol] w₁w₃ [symbol] (step 2). At this point, the algorithm reaches t₃. However, since t₃ can only be assigned to w₁, and w₁ has already used all his capacity (i.e., w₁ is already assigned to t₁ and t₂), t₃ remains unassigned. The algorithm repeats this step to find all the non-contradicting correct matches. Consequently, in step 3, the GR algorithm adds t₁₀ to [symbol] w₂ [symbol] to the set A. Finally, the algorithm stops when it scans through all the correct matches.

### Local Optimization (LO) Approach

The problem with the GR approach is that the assignment is performed in an ad-hoc fashion, and is totally dependent on the order in which the correct matches are scanned. In other words, the spatial tasks are assigned arbitrarily without considering any heuristic to improve the result. The Local Optimization approach adopted from [17] tries to improve the Greedy approach by finding an optimal solution within a neighborhood set of solutions. Consequently, the LO approach first uses the GR approach to find an assignment. Thereafter, it tries to improve the assignment by performing some local searches.

TABLE 2
Illustrating GR steps for the example of FIG. 2

| Steps | A |
|---|---|
| 1 | {(t₁, [symbol] w₁w₂w₃ [symbol] )} |
| 2 | {(t₁, [symbol] w₁w₂w₃ [symbol] ), (t₂, [symbol] w₁w₃ [symbol] )} |
| 3 | {(t₁, [symbol] w₁w₂w₃ [symbol] ), (t₂, [symbol] w₁w₃ [symbol] ), (t₁₀, [symbol] w₂ [symbol] )} |

Details of the LO algorithm are explained with the example of FIG. 2 (see Table 3). The algorithm starts by applying the Greedy approach to find an assignment A. It is clear that A cannot be directly expanded by adding more correct matches. However, it is still possible that if a correct match is removed from A, it may be possible to replace it with more than one correct match in order to increase the number of assigned tasks. Consequently, the algorithm iterates through all the correct matches in the set A, and for every correct match (tᵢ, C), the LO algorithm removes it from the result set A. As shown in step 2 of Table 3, (t₁, [symbol] w₁w₂w₃ [symbol] ) is removed from A. Thereafter, the algorithm searches for the set M′, which is the set of all the non-contradicting correct matches in M that could be added to A−(tᵢ, C). For example, the set M¹ after removing (t₁, [symbol] ω₁ω₂ω₃ [symbol] ) from the set A includes (t₃, [symbol] w₁ [symbol] ), (t₅, [symbol] w₁ [symbol] ), (t₈, [symbol] w₁w₂w₃ [symbol] ), and (t₉, [symbol] w₁ [symbol] ). Note that even though these correct matches do not contradict with the set A, they may contradict with each other. For example, (t₃, [symbol] w₁ [symbol] ) and (t₅, [symbol] w₁ [symbol] ) in the set M′ contradicts with each other. The reason is that ω₁ is already been assigned to t₂, which leaves him with only one remaining capacity to be assigned to either t₃ or t₅. Therefore, the algorithm needs to compute the set A′ with maximum number of non-contradicting correct matches, given the set M′. That is, it needs to solve the MCTA problem for the set M′. Note that the set M′ is a much smaller set as compared to M. Therefore, computing the maximum assignment using any of the optimal approaches is feasible. In the example, the set A′ constructed from M′ includes (t₃, [symbol] w₁ [symbol] ) and (t₉, [symbol] w₁ [symbol] ). Consequently, the algorithm trades A′ for (t₁, C) only if |A′|>1. That is, the algorithm adds A′ to A only if the set A could be expanded by more than one correct match. Otherwise, the already removed correct match (t₁, C) is put back into the result set. As depicted in Step 3 of Table 3, the set A is added to the set A, since it contains two correct matches. (Note: Even if the set M′ was large, the GR approach could be applied to compute the set A′.) Next, the algorithm repeats these steps for the next correct match (t₂, [symbol] w₁w₃ [symbol] ). As step 5 of Table 3 shows, the algorithm trades (t₂, [symbol] w₁w₃ [symbol] ) with the two correct matches (t₂, [symbol] w₃ [symbol] ) and (t₅, [symbol] w₁ [symbol] ). At this point, the LO algorithm stops, since no more such trading is possible. It can be seen from Table 3 that by applying the LO approach, the number of assigned tasks increases as compared to that of the GR approach.

TABLE 3
Illustrating the LO steps for the example of FIG. 2.

| Steps | A |
|---|---|
| 1 | $\{ ( {t}_{1} , 〈 {w}_{1} {w}_{2} {w}_{3} 〉 ) , ( {t}_{2} , 〈 {w}_{1} {w}_{3} 〉 ) , ( {t}_{10} , 〈 {w}_{2} 〉 ) \}$ |
| 2 | $\{ ( {t}_{2} , 〈 {w}_{1} {w}_{3} 〉 ) , ( {t}_{10} , 〈 {w}_{2} 〉 ) \}$ |
| 3 | $\{ \begin{matrix}( {t}_{2} , 〈 {w}_{1} {w}_{3} 〉 ) , ( {t}_{10} , 〈 {w}_{2} 〉 ) , ( {t}_{3} , 〈 {w}_{1} 〉 ) \\ ( {t}_{9} , 〈 {w}_{3} 〉 )\end{matrix} \}$ |
| 4 | $\{ ( {t}_{10} , 〈 {w}_{2} 〉 ) , ( {t}_{3} , 〈 {w}_{1} 〉 ) , ( {t}_{9} , 〈 {w}_{3} 〉 ) \}$ |
| 5 | $\{ \begin{matrix}( {t}_{10} , 〈 {w}_{2} 〉 ) , ( {t}_{3} , 〈 {w}_{1} 〉 ) , ( {t}_{9} , 〈 {w}_{3} 〉 ) \\ ( {t}_{2} , 〈 {w}_{3} 〉 ) , ( {t}_{5} , 〈 {w}_{1} 〉 )\end{matrix} \}$ |

### Heuristic-Based Greedy (HGR) Approach

Even though the LO approach improves the assignment as compared to the GR approach, its major drawback is that it is computationally expensive. The reason is that unlike the GR approach which scans only once through the set of correct matches to solve the MCTA problem, the LO approach needs to iteratively scan through the result set until no more local optimization is possible. This limits its real-world applicability as most crowdsourcing applications require a real-time assignment of tasks to workers.

In this section, the goal is to employ a number of heuristics to increase the number of assigned tasks while keeping the computation cost as low as the GR approach. This approach may be referred to as a Heuristic-based Greedy (HGR) approach which utilizes three heuristics. The first heuristic filters out a set of correct matches that do not potentially contribute to the final result. The second heuristic is based on the intuition that it would be more beneficial to utilize less number of workers when assigning a task. This would allow those workers to be assigned to other tasks; thus, increasing the total number of assigned tasks. The third heuristic takes into account the travel cost (e.g., in time or distance) of the workers during the assignment process. Therefore, the intuition here is to give more priority to the workers who are closer to a given spatial task. In the following sections, each of the heuristics are examined in tum. Thereafter, an examination is given for the HGR algorithm that can integrate all the three heuristics into the GR approach.

### Filtering Heuristic

In order to solve the MCTA problem, one needs to compute the potential match set for every spatial task t. This requires computing the aggregate reputation score for any combination of workers whose spatial regions contain the task t. Consequently, repeating this step for all the spatial tasks can create a large number of correct matches. This renders the existing approaches inefficient. The idea is to prune a set of correct matches which potentially do not contribute to the final result. In the following, a definition is first given for the term domination. Next, a lemma is defined, which depicts how one can filter out a set of correct matches.

DEFINITION 10 (DOMINATION). Given two correct matches (t,C)εM and (t, C′)εM, the correct match (t, C) can be considered to dominate the correct match (t,C′) if C⊂C′.

LEMMA 2. Given the set M (Definition 8), let A be the output of an assignment algorithm (e.g., GR). Moreover, let DεM be the set of all correct matches being dominated by the rest of the correct matches in M−D. Let A be the output of the assignment algorithm, given the set M=M−D. Consequently, |Â≧|A∥. That is, the set D can be safely pruned from M without degrading the final result.

PROOF. The proof is trivial. Let (t, C′)εD. Also, let (t, C′) be dominated by (t, C)εM−D. Now, assume that the task t is assigned to the set C′ in A. The correct match (t, C′) can always be replaced with (t,C) in A, since C is the subset of the workers in C′. Moreover, since there exists a set of workers in C′ who are not in C, replacing (t, C′) with (t, C) will release some workers to be assigned to other tasks. Consequently, this may result in increasing the number of assignments. Thus, for \hat{M}=M−D, |Â|≧|A|.

Given Lemma 2, by removing all the correct matches in the set M which are already dominated by other correct matches in M, the final result may be improved. For the example of FIG. 2, the set of correct matches which can be pruned from the set M is D={(t₂, [symbol] w₁w₃ [symbol] ) (t₁₀, [symbol] w₂w₃ [symbol] )}. In general, the above lemma can be utilized during the construction of the potential match set for every spatial task t. That is, for every set C, whose aggregate reputation score satisfies a, the correct matches dominated by the set C are no longer constructed. This results in a lower computation cost during the generation of the correct matches as well as less number of correct matches to scan during the assignment process.

### Least Worker Assigned (LWA) Heuristic

One of the drawbacks of the GR approach was that the correct matches were scanned in an arbitrary order. However, the order in which the correct matches are scanned becomes important, particularly when the list is scanned only once. Note that in an extreme case, a proper ordering of the correct matches may result in the optimal answer. With this heuristic, the goal is to assign a particular ordering to the list of correct matches, which may improve the final result. Higher priorities can be assigned to the correct matches with less number of workers. That is, given two correct matches (t,C) and (t′,C′), where |C|<|C′|, (t,C) has a higher priority. For example, in FIG. 2, between the two correct matches (t₁, [symbol] w₁w₂w₃ [symbol] ) and (t₃, [symbol] w₁ [symbol] ), higher priority can be assigned to (t₃, [symbol] w₁ [symbol] ), since the spatial task t₃ requires less number of workers to be performed as compared to t₁. Consider every worker as a resource, the intuition is that these resources are limited (i.e., workers have limited capacities). Consequently, it would be much wiser to waste less number of resources for a given spatial task whenever possible, so that those resources can be used by the rest of the tasks; thus, increasing the total number of assigned tasks.

### Least Aggregate Distance (LAD) Heuristic

So far, the travel cost (e.g., in time or distance) of the workers has not been considered during the assignment process. With spatial crowdsourcing, the travel cost may become a critical issue since workers should physically go to the location of the spatial task in order to perform the task. Consequently, based on this heuristic, the idea is to give more priority to workers whose aggregate distance to a given spatial task is less than those of the other workers.

The travel cost between a worker w and a spatial task t may be defined in terms of, e.g., the Euclidean distance between the two (or, other metrics such as network distance are easily applicable), denoted by d(t,ω). Moreover, given a set of workers C, who should be assigned to the task t simultaneously, the aggregate distance, denoted by ADist(t,C), may be defined as the sum of the Euclidean distances between the spatial task t and all the workers in C (i.e.,

ADist(t,C)=Σ_{wεC}d(t,w)).

### HGR Algorithm

In this section, details of the HGR algorithm are explained by combining all the above mentioned heuristics. The HGR algorithm contains three preprocessing steps. The rest works similar to the GR approach. In the first step, it utilizes the pruning heuristic to remove the set of correct matches dominated by the rest of the correct matches in M. The reason the pruning step is performed first is that as already discussed, the set of dominated correct matches are pruned during the construction of the set M, which may improve the overall computation cost. Next, the HGR algorithm orders the set of correct matches by the number of workers and the aggregate distance, respectively. That is, the algorithm first gives higher priority to the correct matches with less number of workers. Subsequently, among those with equal number of workers, it gives higher priority to those with smaller aggregate distances. The reason that the LWA heuristic is utilized before the LAD heuristic is that the LWA heuristic is trying to increase the number of assigned tasks (the primary objective of MCTA), whereas the LAD heuristic takes into account the travel cost of the workers, which is secondary in MCTA.

### Performance Evaluation

Several experiments were conducted on both real-world and synthetic data to evaluate the performance of the proposed approaches: GR, LO, and HGR. Below, description is provided for the experimental methodology and experimental results.

### Experimental Methodology

Three sets of experiments were performed. In the first two sets of experiments, the scalability of the proposed approaches were evaluated by varying both the average number of workers whose spatial regions contain a given spatial task, namely workers per task (W/T), and the average number of spatial tasks which are inside the spatial region of a given worker, denoted by tasks per worker (T/W). In the rest of the experiments, an evaluation was made of the impact of the workers' capacity constraints on the performance of the approaches. Note that every worker has two constraints: maxT and R. However, an evaluation was made on only the impact of one of them (i.e., maxT) on the approaches, since both constraints have similar effects. With these experiments, three performance measures were utilized: 1) the total number of assigned tasks, 2) CPU cost, which is the time (in seconds) it takes to solve the MCTA problem, and 3) the average of the aggregate travel cost for a given task, which is the sum of the travel costs of all the workers who are assigned to the task. The travel cost is measured in terms of the Euclidean distance between the worker and the location of the task. Finally, experiments were conducted on both synthetic (SYN) and real-world (REAL) data sets. For the experiments on synthetic data, two distributions were used: uniform (SYN-UNIFORM) and skewed (SYN-SKEWED). In the following, the data sets are discussed in further detail.

With the first set of synthetic experiments, in order to evaluate the impact of WIT, three cases were considered (see Table 4), sparse, medium, and dense, in which the average number of W/T is 2, 4, and 8, respectively. This means that an area can be considered as worker-dense, if the average number of workers who are eligible to perform a spatial task is 8, whereas in a sparse case, the average number of WIT is 2. In the experiments on SYN-UNIFORM, the average number of W/T varies with a small standard deviation (from 1.1 to 2.5), whereas in the experiments on SYN-SKEWED, the average number of WIT varies with a large standard deviation (between 4 to 16). In order to generate the SYN-SKEWED data set, 99% of the workers were formed into four Gaussian clusters (with σ=0.05 and randomly chosen centers) and the other 1% of the workers were uniformly distributed. With the second set of synthetic experiments, in order to evaluate the impact of T/W, three cases were considered (Table 5), sparse, medium, and dense, in which the average number of T/W is 5, 15, and 25, respectively. Note that the assumption used was that the number of tasks is usually higher than the number of available workers at a given time instance. Similar to the previous set of experiments, with the uniform distribution (SYN-UNIFORM), the average number of T/W varies with a small standard deviation (from 2 to 5), whereas with the skewed distribution (SYN-SKEWED), the average number of T/W varies with a large standard deviation (between 25 to 80). Moreover, in order to generate the SYNSKEWED data set, a similar approach to that of WIT was followed. Finally, with the last set of experiments, the average number of maxT was varied for every worker between 5 to 15. With this set of experiments, only the experiments on SYN-UNIFORM, in which the value of maxT varies with a small standard deviation (between 1 to 3), were reported on since similar trends were observed in the skewed case.

The real-world data set was obtained from Gowalla, a location-based social network, where users are able to check in to different spots in their vicinity. The check-ins include the location and the time that the users entered the spots. Spatial tasks were defined for 115580 spots (e.g., restaurants) in the state of California. An example of a spatial task description can be: “Does the cleanness of the spot matches its ratings?”. Moreover, it was assumed that Gowalla users are the workers of the spatial crowdsourcing system, since users who check in to different spots may be good candidates to perform spatial tasks in the vicinity of those spots. For the experiments, the check-in data over a period of one day were used, covering the state of California. For this particular set of experiments, the average number of W/T was around 4 with standard deviation of 9. This also confirms the choices of parameters for synthetic datasets.

Finally, in all of the experiments, for both the reputation score of every worker and the confidence probability of every spatial task, a number was randomly selected between 0 to 1 from a uniform distribution. Furthermore, unless mentioned otherwise, the default values for average WIT is 2, the average T/W is 15, and the average value of maxT is 10 with standard deviations 1.1, 2, and 1, respectively. For each of the experiments, 500 cases were run, and the average of the results were reported. Finally, experiments were run on an Intel® Core™2 @ 2.66 GHz processor with 4 GB of RAM.

TABLE 4
Distribution of the synthetic data for W/T

| W/T | SYN-UNIFORM | SYN-SKEWED |
|---|---|---|
| Sparse | Avg: 2, SD: 1.1 | Avg: 2, SD: 4 |
| Medium | Avg: 4, SD: 1.7 | Avg: 4, SD: 10 |
| Dense | Avg: 8, SD: 2.5 | Avg: 8, SD: 6 |

TABLE 5
Distribution of the synthetic data for W/T

| T/W | SYN-UNIFORM | SYN-SKEWED |
|---|---|---|
| Sparse | Avg: 5, SD: 2 | Avg: 5, SD: 25 |
| Medium | Avg: 15, SD: 3 | Avg: 15, SD: 50 |
| Dense | Avg: 25, SD: 5 | Avg: 25, SD: 80 |

Effect of Number of Workers per Task (W/T)

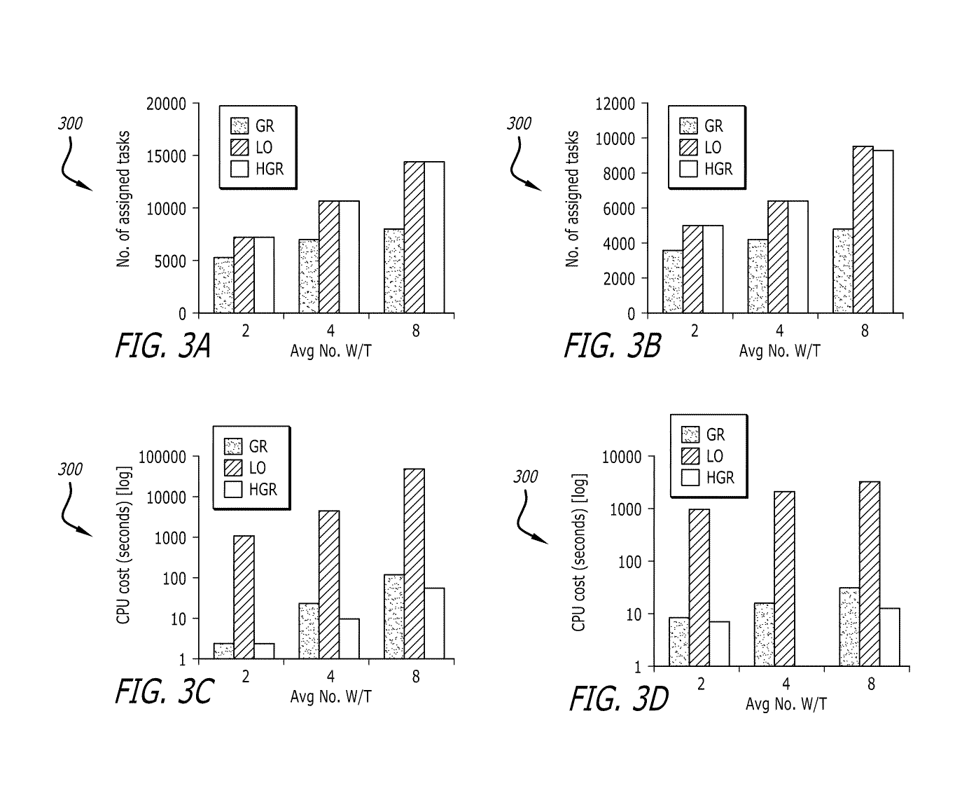

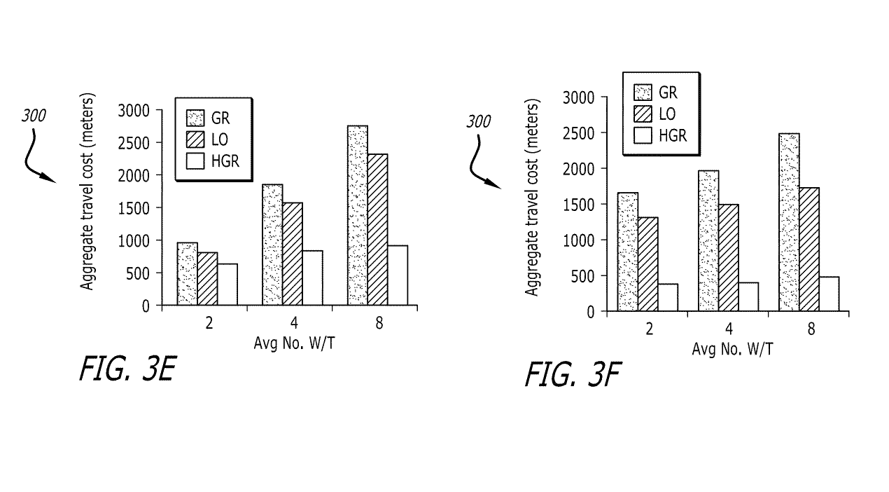

In the first set of experiments, the scalability of the approaches was evaluated by varying the number of workers whose spatial regions contain a given spatial task, as shown in FIGS. 3A-3F.

FIGS. 3A-3B depict the result of the experiments on both SYNUNIFORM and SYN-SKEWED. As the figures demonstrate, the assignment increases as the number of WIT grows. The reason is that more resources become available to perform tasks. The figures also show that HGR is outperforming GR by up to 2 times, which shows the effectiveness of the heuristics used. Moreover, the experiments demonstrate that HGR acts similar to the LO approach, which proves that by only integrating the heuristics to the GR approach, results can be obtained that are similar to the case where local optimization is/was iteratively performed. Another observation from this set of experiments is that the impact of the heuristics becomes more significant for larger number of WIT. The reason is that in a worker-dense area, there is a higher chance that more than one worker is assigned to a given task. Thus, applying pruning and LWA heuristics becomes more critical. Finally, it is observed that the overall number of assigned tasks is higher for the uniform data as compared to that of the skewed data. The reason is that in the skewed case, many tasks fall outside the spatial regions of the workers, and therefore cannot be assigned.

FIGS. 3C-3D depict the impact of varying the number of WIT on the CPU cost (logarithmic scale) using uniform and skewed data, respectively. A first observation is that both GR and HGR approaches perform significantly better than LO approach in terms of the CPU cost. The reason is that while both GR and HGR scan once through the list of correct matches, with LO, the algorithm iteratively scans the list until no more local optimization is possible. Moreover, one can observe that the superiority of HGR as compared to GR in terms of the CPU cost is up to 2.7 times for the uniform data set and up to 2.2 times for the skewed data set. This is due to the pruning heuristic, since a large number of correct matches are pruned, and therefore do not need to be processed. Finally, LO is not applicable to real-world crowdsourcing applications due to its large CPU cost.

FIGS. 3E-3F demonstrate the impact of varying the number of WIT on the aggregate travel cost of the workers in performing a given task using uniform and skewed data, respectively. The figures show that as the number of WIT grows, there is a higher chance that more than one worker is assigned to a given task, and therefore the aggregate travel cost of the workers increases. It may also be observed that HGR performs significantly better than GR and LO (up to 3.1 times for the uniform data and up to 5 times with the skewed data). Moreover, the experiments show that the LAD heuristic becomes more useful in a worker-dense area, where more workers are assigned to a given task. Finally, experiments show more improvements of the heuristics on the skewed data set, since with the skewed data set, the average number of WIT changes with a higher variance. Therefore, a task may be assigned to a large number of workers, which makes the disclosed heuristics more useful.

### FIG. 3. Effect of W/T on Synthetic Data

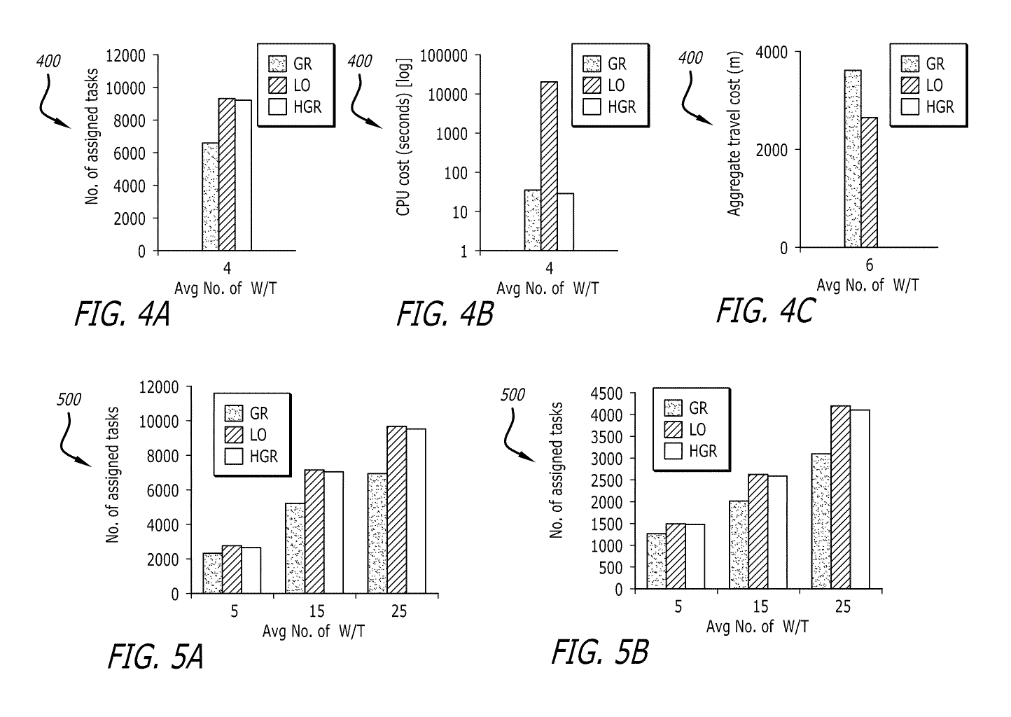

FIGS. 4A-4C depict experiments on real data, in which the average number of WIT is 4. The experiments show similar results in terms of HGR outperforming the GR approach in all cases, which proves the effectiveness of the disclosed heuristics in a real-world distribution of workers and tasks.

### Effect of Number of Tasks Per Worker (T/W)

In the next set of experiments, the scalability of the approaches is evaluated by varying the average number of tasks which are located inside the spatial region of a given worker. FIGS. 5A-B includes views 5A and 5B and depicts the effect of T/W-Synthetic data.

FIGS. 5A-5B depict the result of experiments on both SYN-UNIFORM and SYN-SKEWED. This set of experiments only reported on the impact of varying T/W on the number of assigned tasks, since the rest was similar to the previous set of experiments. As the figures show, the total number of assigned tasks increases as T/W grows. The reason is that more tasks are available to be performed by workers. Moreover, experiments on both uniform and skewed data sets demonstrate the superiority of HGR over the GR approach by up to 30% with the uniform data, and up to 26% with the skewed data. Furthermore, as the figures show, the impact of the disclosed heuristics becomes more significant in medium and dense areas, whereas in sparse areas all approaches perform similarly. The reason is that in all of the experiments, the average value of maxT was fixed to 10. In a task-sparse area, every worker has on average 5 tasks inside his region. Therefore, due to abundance of the resources, all the assignment algorithms achieve similar results. Effect of Maximum Acceptable Tasks (maxT) Constraint

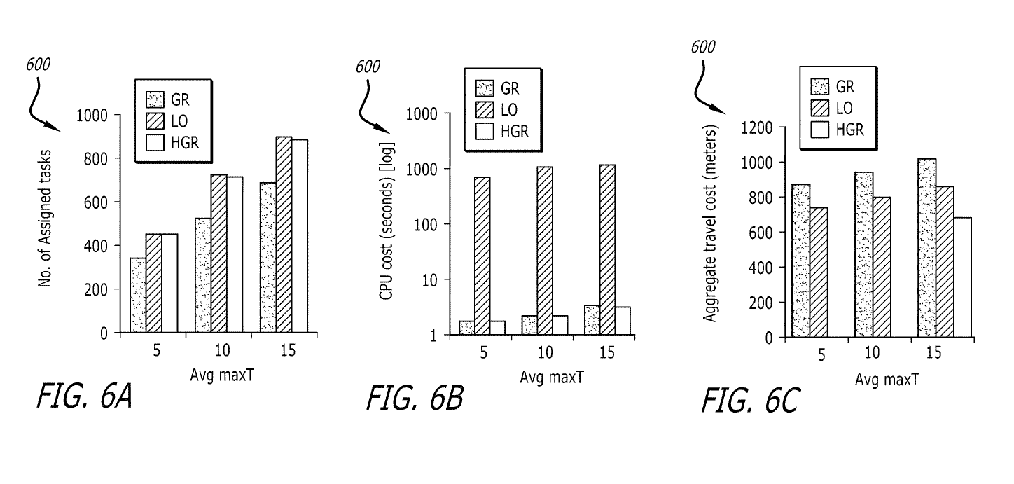

In the final described set of experiments, the performance of the approaches was measured with respect to increasing the average value of maxT for every worker from 5 to 15. FIGS. 6A-6C, include views6A, 6B, and 6C, and shows the effect of maxT-SYN-UNIFORM.

FIG. 6] A illustrates an increase in the number of assigned tasks as maxT grows. The reason is that with an increase in maxT, workers are willing to do more tasks, and thus, the number of assignment increases. Moreover, similar to the previous set of experiments, the superiority of the greedy approaches (GR and HGR) was observed as compared to LO in terms of the CPU cost (FIG. 6B). Finally, as FIG. 6C depicts, HGR outperforms both GR and LO in terms of the aggregate travel cost by up to 1.5 times.

The main observation from this set of experiments is that the HGR approach outperforms the GR approach in all cases, while its performance in terms of task assignment is close to the LO approach. Moreover, due to the high CPU cost, the LO approach is not applicable to the real-world applications. This states that the disclosed HGR approach can efficiently solve the MCTA problem, while achieving similar result comparing to the optimization approach.

### MediaQ—Exemplary Embodiments

Exemplary embodiments of GeoCrowd and/or GeoTruCrowd can utilize MediaQ, which is a novel online media management system to collect, organize, share, and search mobile multimedia contents using automatically tagged geospatial metadata. User-generated-videos can be uploaded to the MediaQ from users' smartphones, e.g., iPhone and/or Android-based devices, and displayed accurately on a map interface according to their automatically sensed geospatial and other metadata. The MediaQ system provides the following distinct features. First, individual frames of videos (or any meaningful video segments) are automatically annotated by objective metadata which capture four dimensions in the real world: the capture time (when), the camera location and viewing direction (where), several key-words (what) and people (who). These data may be referred to as W4-metadata and they can be obtained by utilizing camera sensors, geospatial and computer vision techniques, etc. Second, a new approach of collecting multimedia data from the public has been implemented using spatial crowdsourcing, which allows media content to be collected in a coordinated manner for a specific purpose. Lastly, flexible video search features are implemented usingW4 metadata, such as directional queries for selecting multimedia with a specific viewing direction.

The present disclosure describes the design of a comprehensive mobile multimedia management system, MediaQ, and experience in its implementation. Extensive real world experimental case studies demonstrate that MediaQ can be an effective and comprehensive solution for various mobile multimedia applications.

### Introduction

Due to technological advances, an increasing number of video clips are being collected with various devices and stored for a variety of purposes such as surveillance, monitoring, reporting, or entertainment. These acquired video clips contain a tremendous amount of visual and contextual information that makes them unlike any other media type. However, even today, it is very challenging to index and search video data at the high semantic level preferred by humans. Text annotations of videos can be utilized for search, but high-level concepts must often be added by hand and such manual tasks are laborious and cumbersome for large video collections. Content-based video retrieval—while slowly improving in its capabilities—is challenging, computationally complex and unfortunately still often not satisfactory.

Some types of video data are naturally tied to geographical locations. For example, video data from traffic monitoring may not have any meaning without its associated position information. Thus, in such applications, one needs a specific location to retrieve the traffic video at that point or in that region. Hence, combining video data with its location coordinates can provide an effective way to index and search videos, especially when a repository handles an extensive amount of video data. Since most videos are not panoramic the viewing direction also becomes very important.

In this study, a focus is provided specifically on mobile videos generated by the public. By 2018, more than 69% of the worldwide Internet traffic is expected to result from video data transmissions from and to mobile devices [12]. Mobile devices such as smartphones and tablets can capture high-resolution videos and pictures. However, they can only store a limited amount of data on the device. Furthermore, the device storage may not be reliable (e.g., a phone is lost or broken). Hence, a reliable backend storage is desirable (e.g., Dropbox, Google Drive, iCloud). Unfortunately, it is very difficult to later search these large storage systems to find required videos and pictures as they are usually file-based and without a facility to systematically organize media content with appropriate indices. This becomes especially troublesome when a huge amount of media data and a large number of users are considered. Moreover, current online mobile video applications mainly focus on simple services, such as storage or sharing of media, rather than integrated services towards more value-added applications.

These issues are addressed with the proposed MediaQ system by attaching geospatial metadata to recorded mobile videos so that they can be organized and searched effectively. Geo-tagged video search may likely play a prominent role in many future applications. However, there still exist many open, fundamental research questions in this field. Most captured videos are not panoramic and as a result the viewing direction is of great importance. Global positioning system (GPS) data only identify object locations and therefore it is imperative to investigate the natural concepts of viewing direction and viewpoint. For example, one may be interested to view a building only from a specific angle. The question arises whether a video repository search can accommodate such human friendly queries. The collection and fusion of multiple sensor streams such as the camera location, field-of-view, direction, etc., can provide a comprehensive model of the viewable scene. The objective then is to index the video data based on the human viewable space and therefore to enable the retrieval of more meaningful and recognizable scene results for user queries. Cameras may also be mobile and thus the concept of a camera location is extended to a trajectory. Consequently, finding relevant video segments becomes very challenging.

One example query that a user may pose to an existing video hosting site could be as follows. Consider YouTube as an example to answer the following query/command: “Find images (or video frames) of myself captured in front of Tommy Trojan (a statue of the University of Southern California mascot) during the 2013 USC-UCLA football game day.” A search like this will retrieve a top video called Trojan Tailgate TV Ep. 1 which is related to the query, but is not as specific as requested in the query. This example illustrates that even in the presence of recent advanced technologies, it can still be very difficult to index and search videos and pictures at a large scale.

Most up to date data management technologies can handle text data very efficiently (as exemplified in Google search) but provide limited support for videos and images (as can be seen from the YouTube search facilities). Unlike text documents, understanding visual content correctly has turned out to be a very challenging task. In the past, two main approaches have been utilized to annotate videos and images for indexing and searching. First, manual text annotations by users have been the most practical and preferred way to identify textual keywords to represent visual content. However, this approach suffers from the following drawbacks: 1) the human perception of visual content is subjective, 2) manual annotations are both error-prone and time consuming. Second, content-based retrieval techniques have been applied to automate the annotation process. However, such methods also suffer from their own limitations such as: 1) inaccurate recognition of visual content, 2) high computational complexity that makes them unsuitable for very large video applications, and 3) domain specificity such that they cannot handle open-domain user videos.

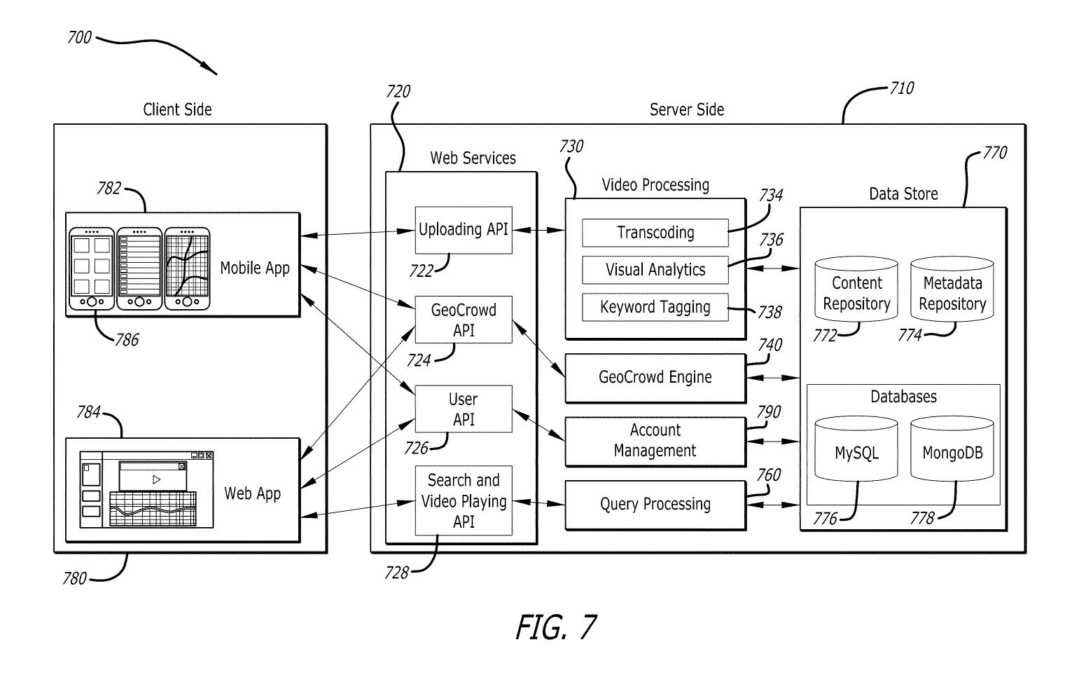

In an effort towards addressing the above challenges, embodiments of the MediaQ technology are introduced as a novel mobile multimedia management system. FIG. 7 illustrates the overall structure of the implemented framework or system 700, with subcomponents. As shown system 700 can include a server side 710 and a client side 780. The server side 710 can include a number of Web services/features/modules 720, including but not limited to, an uploading application programming interface (API) 722, a GeoCrowd API 724, a user API 726, and a Search and Video Playing API 728. The server side 710 can also include a number of video processing features/services/modules 730, including but not limited to a transcoding module 734, a visual analytics module 736, and a keyword tagging module 738. The server side 710 can also include a GeoCrowd (or GeoTruCrowd) engine 740 as shown. Account management and query processing modules 750 and 760 may also be included. A data store 770 may be present, which may include a content repository module 772, a metadata repository 774, and/or databases such as MySQL module 776, and MongoDB 778. Client side 780—can include a mobile app module 782 and a Web app module, e.g., either of which may be used on a mobile device 786 such as used by a worker for an assigned task. Of course other features, or services, or modules may be included within system 700.

Some specific contributions of examples of the presented MediaQ system are as follows.

MediaQ technology (embodiments of which are referred to as “MediaQ”) can utilize an underlying model of sensor metadata fused with mobile video content. Individual frames of videos (or any partial video segment) are automatically, without manual intervention, annotated by objective metadata that capture time (when), location (where), and keywords (what).

Novel functionalities are integrated that facilitate the management of large video repositories. As a key innovative component, spatial crowdsourcing is implemented as a media collection method. Automatic keyword tagging enhances the search effectiveness while panoramic image generation provides an immersive user experience.

As a fully integrated media content and management system, MediaQ is designed and implemented to provide efficient and scalable performance by leveraging its underlying sensor-fusion model. Additional functions (e.g., video summarization) can be integrated by taking advantage of MediaQ's efficient base architecture.

### Spatial Crowdsourcing (GeoCrowd) Utilizing MediaQ

While crowdsourcing has recently attracted interest from both research communities (e.g., database, image processing, NLP) and industry (e.g., Amazon's Mechanical Turk and Crowd Flower), only a few earlier approaches have studied spatial crowdsourcing which closely ties locations to crowdsourcing.

A well-developed concept of spatial crowdsourcing was first introduced for GeoCrowd (as described above for FIGS. 1-6), in which workers send their locations to a centralized server and thereafter the server assigns nearby tasks to every worker with the objective of maximizing the overall number of assigned tasks. In another work, the problem of location-based crowdsourcing queries over Twitter was studied. This method employs a location-based service (e.g., Foursquare) to find appropriate people to answer a given query. This work does not require that users should go to the specific locations and perform the corresponding tasks. Instead, it selects users based on their historical Foursquare check-ins. Participatory sensing is related to spatial crowdsourcing, in which workers form a campaign to perform sensing tasks. Examples of participatory sensing campaigns include some that used GPS-enabled mobile phones to collect traffic information.

Volunteered geographic information (or VGI) is also related to spatial crowdsourcing. VGI (e.g., WikiMapia, Open-StreetMap, and Google Map Maker) aims to create geographic information voluntarily provided by individuals. However, the major difference between VGI and spatial crowdsourcing is that in VGI, users participate, without needing to be solicited, by randomly contributing data, whereas in spatial crowdsourcing, a set of spatial tasks are explicitly requested by the requesters, and workers are required to perform those tasks.

### MediaQ Framework

### Overview

The schematic design of an exemplary MediaQ system is 700 illustrated in FIG. 7.

Client-side components 780 can be used for user interaction, i.e., the Mobile App 782 and the Web App 784. The Mobile App 782 is mainly for video capturing with sensed metadata and their uploading. The Web App 784 allows searching the videos and issuing spatial crowdsourcing task requests to collect specific videos.

Server-side components 710 can include Web Services, Video Processing, GeoCrowd Engine, Query Processing, Account Management, and Data Store, as described above. The Web Service is the interface between client-side and server-side components. The Video Processing component performs transcoding of uploaded videos so that they can be served in various players. At the same time, uploaded videos are analyzed by the visual analytics module to extract extra information about their content such as the number of people in a scene. One can plug in open source visual analytics algorithms here to achieve more advanced analyses such as face recognition among a small group of people such as a user's family or friends. Automatic keyword tagging is also per-formed at this stage in parallel to reduce the latency delay at the server. Metadata (captured sensor data, extracted keywords, and results from visual analytics) are stored separately from uploaded media content within the Data Store. Query Processing supports effective searching for video content using the metadata in the database. Finally, task management for spatial crowdsourcing can be performed via the GeoCrowd engine.

Media Collection with Metadata

### Field of View Modeling

In the approach described herein, the media content (i.e., images and videos) is represented based on the geospatial properties of the region it covers, so that large video collections can be indexed and searched effectively using spatial database technologies. This area can be referred to as the Field Of View (or FOV) of the video scene.

FIG. 8 illustrates a 2D Field of View (FOV) model. As shown in FIG. 8, a scene of video frame fᵢ is represented in a 2D FOV model 800 with four parameters, f≡ [symbol] p, θ, R, α [symbol] , where p is the camera position consisting of the latitude and longitude coordinates (an accuracy level can be also added) read from the GPS sensor in a mobile device, θ represents the viewing direction \vec{d}, the angle with respect to the North obtained from the digital compass sensor, R is the maximum visible distance at which an object can be recognized, and a denotes the visible angle obtained from the camera lens property at the current zoom level. For simplicity, this study assumes that the camera is always level so the vector \vec{d} points towards the camera heading on the horizontal plane only. Note that extending a 2D FOV to a 3D FOV is straightforward. Let [symbol] be the video frame set {f|∀fεv,∀ᵥε [symbol] }. All the video frames of all the videos in [symbol] are treated as a large video frame set [symbol] .

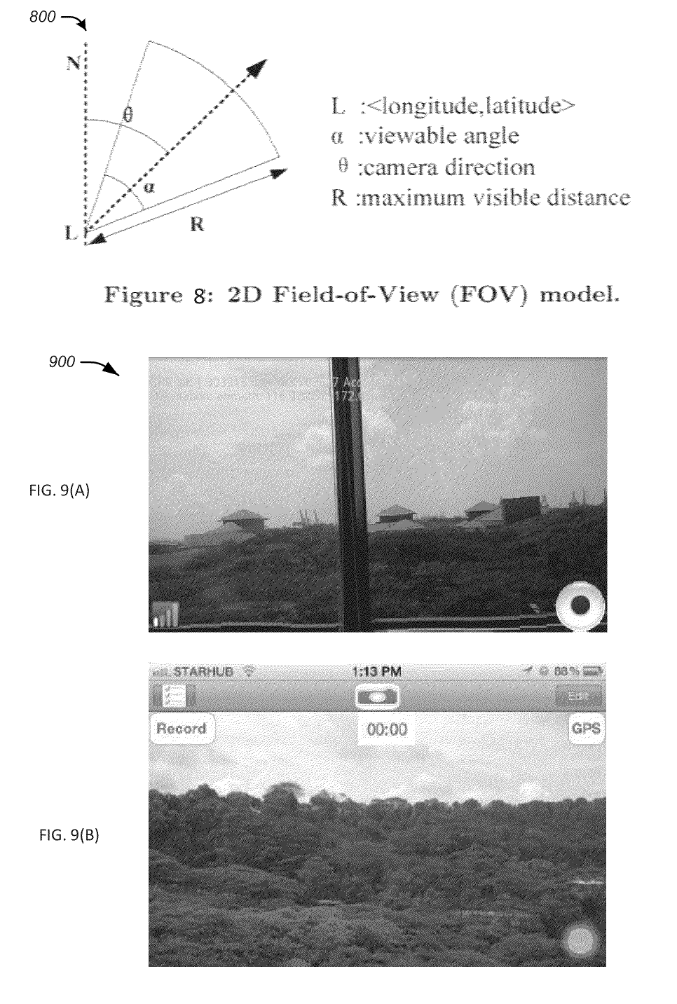

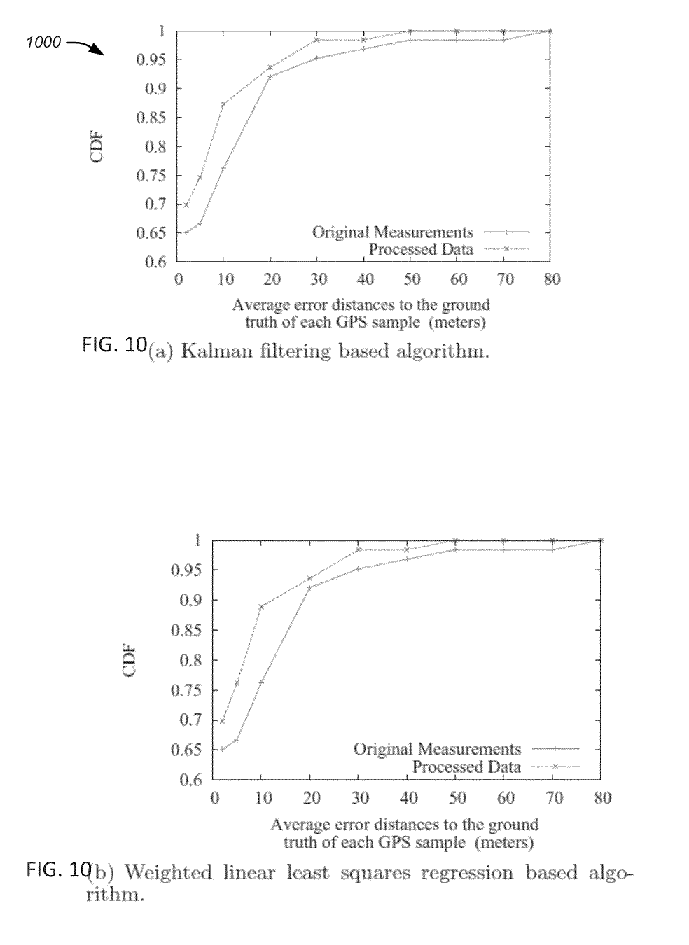

Within a suitable mobile application (or “app”), e.g., as detailed below, a custom geospatial video module can be implemented to acquire, process, and record the location and direction metadata along with captured video streams. The app can record encoded videos (e.g., encoded according to H.264 or any other encoding standard) at a desired resolution (e.g., DVD-quality). To obtain the camera orientation, the app can employ the digital compass and accelerometer sensors in the mobile device. Camera location coordinates can be acquired from the embedded GPS receiver sensor. The collected metadata can be formatted with the JSON data-storage and -interchange format. Each metadata item in the JSON data can correspond to the viewable scene information of a particular video frame fᵢ. For the synchronization of the metadata with video content, each metadata item is assigned an accurate timestamp and video time-code offset referring to a particular frame in the video. The frame rate of the collected videos is 24 frames per second. Note that each mobile device model may use different sampling frequencies for different sensors. Ideally one FOV scene quadruplet [symbol] p, θ, R, α [symbol] is acquired per frame. If that is not feasible and the granularity is coarser due to inherent sensor errors, linear interpolation can be performed to generate quadruplets for every frame. FIGS. 9A-B show the screenshots from an acquisition app. The recorded geo-tagged videos can be uploaded to the server, where post processing and indexing is performed, e.g., concurrently or afterwards.

FIGS. 9A-B depict two screenshots of the media collection with metadata module in our mobile app for Android-based (top) and iOS-based (bottom) smartphones.

### Positioning Data Accuracy Enhancement

As described previously, p is the latitude/longitude coordinate that indicates the camera location which is obtained from an embedded GPS receiver. The accuracy of the location data is very important in embodiments of the disclosed MediaQ approach. However, in reality, the captured locations may not be highly exact due to two reasons: 1) the varying surrounding environmental conditions (e.g., reflections of signals between tall buildings) during data acquisition, and 2) inherent sensor errors (e.g., the use of low-cost sensors in mobile devices). In an exemplary system, the accuracy of the positioning data can be enhanced with a post-processing step immediately after the server receives meta-data. In some embodiments, a data correction algorithm based on Kalman filtering and weighted linear least square regression can be used, as described below.

An original GPS reading pₖ is always accompanied with an accuracy measurement value αₖ. The accuracy measure indicates the degree of closeness between a GPS measurement pₖ and its true, but unknown position, say gₖ. If αₖ is high then that means that the actual position gₖ is far away from pₖ. A model of location measurement noise with pₖ and αₖ can be utilized, where the probability of the real position data is assumed to be normal distributed with a mean of pₖ and its standard deviation σₖ. Then one can set σₖ²=g(αₖ), where the function g is monotonically increasing.

FIGS. 10A-B depict two graphs showing the cumulative distribution function of average error distances for two different algorithms, 10A based on Kalman filtering, and 10B based on linear-least-squares regression. The height of each point represents the total amount of GPS sequence data files whose average distance to the ground truth positions is less than the given distance value. FIG. 10 illustrates a Cumulative Distribution Function (CDF) for both algorithms. The results show an increased proportion of GPS data with low average error distance and a shortening of the largest sequence average error distance by around 30 meters (the line of processed data meets y=1 at x=50 m, while the line of the original measurements achieves a value of one at x=80 m).

### Kalman Filtering-Based Correction.

The correction process can be modeled in accordance with the framework of Kalman filters. Two streams of noisy data can be recursively operated on to produce an optimal estimate of the underlying positions. The position and velocity of the GPS receiver can be described by the linear state space:

πₖ=[xₖyₖvₖₓv_{ky}]^{T},

where v_{kX} and v_{ky} are the longitude and latitude component of velocity vₖ. In practice, vₖ can be estimated by some less uncertain coordinates and their timestamp information. The state transition model Fₖ can be defined as

$${F}_{k} = [ \begin{matrix}1 & 0 & Δ {t}_{k} & 0 \\ 0 & 1 & 0 & Δ {t}_{k} \\ 0 & 0 & 1 & 0 \\ 0 & 0 & 0 & 1\end{matrix} ] ,$$

where Δtₖ is the time duration between tₖ and tₖ₋₁. The observation model Hₖ can also be expressed as

$${H}_{k} = [ \begin{matrix}1 & 0 & 0 & 0 \\ 0 & 1 & 0 & 0\end{matrix} ] .$$

Hₖ maps the true state space into the measured space. For the measurement noise model, αₖ can be used to present the co-variance matrix Rₖ of observation noise as follows:

$${R}_{k} = [ \begin{matrix}g ( {a}_{k} ) & 0 \\ 0 & g ( {a}_{k} )\end{matrix} ] .$$

Similarly, Qₖ can also be determined by a diagonal matrix but using the average of g(α_{δ}), whose corresponding position coordinates p_{δ} and timestamp t_{δ} were used to estimate vₖ in this segment. This process model can be applied to the recursive estimator in two alternating phases. The first phase is the prediction, which advances the state until the next scheduled measurement is coming. Second, the measurement value can be incorporated to update the state.

### Weighted Linear Least Squares Regression-Based Correction.

The second correction model is based on a piecewise linear regression analysis. Since the GPS sequence data can be post-processed, one can fully utilize both previous and future GPS readings, from pᵢ to pⱼ, to estimate and update the current position pₖ, where i<k<j. With the assumption that the errors of different GPS readings are uncorrelated with each other and with the independent variable pₖ, the weighted least squares method can be utilized to generate estimators βₖ for each GPS trajectory segment. The longitude and latitude of one GPS value can be denoted as xₖ and yₖ, respectively. With the assumption that xₖ and yₖ are two independent variables, one can estimate model function parameters \hat{β}ₖ for longitude and latitude values with respect to time separately. The goal of the method is to find \hat{β}ₖ for the model which “best” fits the weighted data. By using the weighted least squares method, one can minimize R, where

R=Σₖ₌ᵢ^{j}Wₖₖrₖ²,rₖ=xₖ−f(tₖ,\hat{β}ₖ)

Here rₖ is the residual defined as the difference between the original measured longitude value and the value predicted by the model. The weight Wₖₖ is defined as:

$${W}_{kk} = \frac{1}{{σ}_{k}^{2}}$$

Here σₖ is the deviation of the measurement noise. It is proven that \hat{β}ₖ is a best linear unbiased estimator if each weight is equal to the reciprocal of the variance of the measurement. As described before, the measurement noise can be modeled as a normal distribution with mean xₖ and standard deviation σₖ=g(αₖ) in the longitude dimension. Base on this model, measurements xₖ with a high αₖ value, which indicates high uncertainty, will not have much impact on the regression estimation. Usually, these uncertain measurements reflect many scattered GPS locations, which are far away from where the real positions should be. Considering that the regression line is estimated mostly by the confidence data and these data are mostly temporally sequential, one may be able to correct those spotty GPS locations to positions that are much closer to the real coordinates.

To quantitatively evaluate the two proposed algorithms, the average distance was computed between every processed sample and its corresponding ground truth for each GPS sequence data file, and compare these values to the average distance between every measurement sample and the ground truth position. In experiments, 10,069 GPS samples from 63 randomly selected videos were evaluated. On average, the Kalman filtering based algorithm and the weighted linear least squares regression based algorithms were found to improve the GPS data correctness by 16.3% and 21.76%, respectively.

### Automatic Keyword Tagging

Geocoordinates and directional angles from sensors provide the essential metadata to organize, index, and search FOV's by computer. However, humans are not familiar with such numeric data in browsing videos even when a good map-based user interface is provided. Still, the most efficient and user friendly way for video search is based on textual keywords such as the name of a landmark or a street name, rather than by latitude and longitude. Thus, in MediaQ, every video can be automatically tagged with a variety of keywords during the post processing phase when arriving at the server.

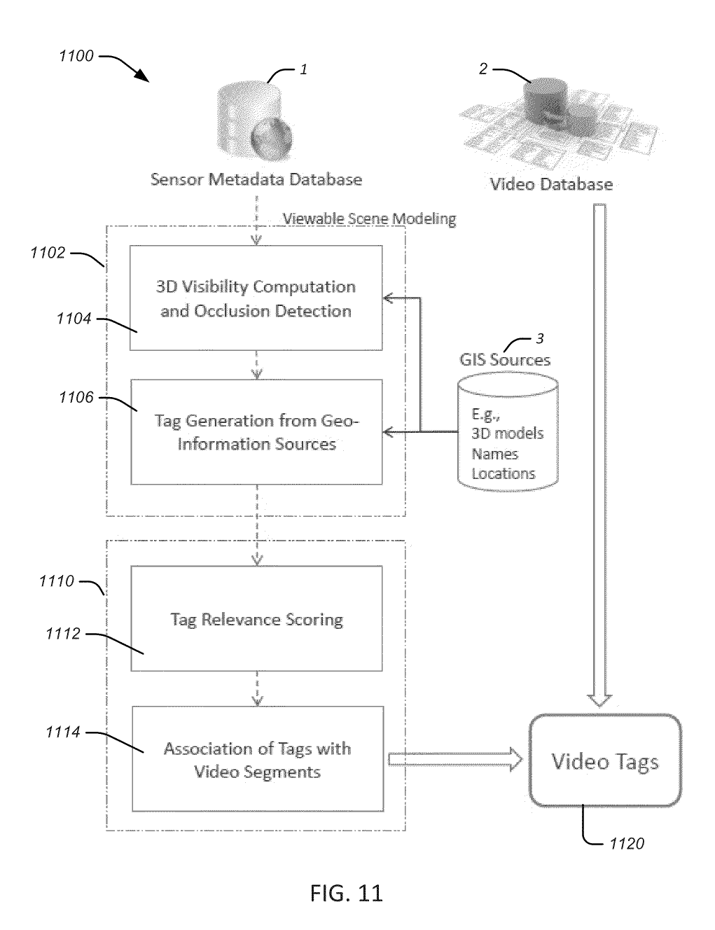

Automatic video tagging is based on captured sensor meta-data (e.g., FOV's) of videos introduced in the work of Shen et al. FIG. 11 illustrates an example of the process flow 1100 in the tagging module of an exemplary MediaQ system.

As illustrated in FIG. 11, the tagging has two major processing stages 1102 and 1108. First, the object information for the covered geographical region is retrieved from various geo-information services (e.g., OpenStreetMap and GeoDec can be used) and visible objects are identified according to 2D visibility computations. Occlusion detection is performed to remove hidden objects. Afterwards, the system generates descriptive textual tags based on the object information retrieved from the geo-information services, such as name, type, location, address, etc. Embodiments of MediaQ currently use the names of visible objects to serve as tags. Tags can be generated and obtained from a limited number of sources. One of the benefits of the approach is that tag generation can be extended in many ways, for example by employing geo-ontologies, event databases and Wikipedia parsing techniques.

As shown in FIG. 11, in the second stage 1106, the following relevance criteria can be introduced to score the relevance of each tag to the scene (e.g., relevance ranking or scoring as described at 1108):
Closeness to the FOV Scene Center: Research indicates that people tend to focus on the center of an image. Based on this observation, objects are favored whose horizontal visible angle range is closer to the camera direction, which is the center of the scene.
Distance: Intuitively, a closer object is likely to be more prominent in the video.

Thus, objects are scored with a higher value if they have a shorter distance to the camera.
Horizontally and Vertically Visible Angle Ranges: An object that occupies a wider range of the scene (either along the width or height) is more prominent from.
Horizontally and Vertically Visible Percentages: These two criteria focus on the completeness of the object's appearance in the video. The video scenes that show a larger percentage of an object are preferable over scenes that show only a small fraction of it.

After obtaining the scores for each criterion, they may be linearly combined to compute the overall score of an object in an individual FOV scene. Additionally, the scores of well-known objects (or landmarks) can be promoted, which are more likely to be searched, for the object information retrieved from the geo-information services that include several clues to identify important landmarks. For example, in OpenStreetMap data, some landmarks (e.g., the Singapore Flyer) are given an “attraction” label. Others are augmented with links to Wikipedia pages, which might be an indirect hint about an object's importance, since something described in Wikipedia is believed to be significant. In the other embodiments, the scores may be further adjusted according to visual information.

After scoring tag relevance 1112, the video segments for which each tag is relevant, e.g., association of tags with video segments 1114, can be determined. Unlike many other video tagging techniques, MediaQ's module associates tags precisely with the video segments in which they appear, rather than the whole video clip. Therefore, when a user searches videos for a certain tag, only those relevant video segments are returned. The ranked tags are stored and indexed to allow further search through textual keywords.

### GeoCrowd Spatial Crowdsourcing

The advanced connectivity of smartphone devices allows users to have ubiquitous access to networks (Wi-Fi and broad-band cellular data connections). As a result, spatial crowd-sourcing using smartphones is emerging as a new paradigm for data collection in an on-demand manner. Spatial crowd-sourcing can be used in MediaQ to collect data efficiently and at scale in the cases where media contents are not avail-able to users, either due to users' lack of interests in specific videos or due to other spatial and temporal limitations.

An exemplary implementation of spatial crowdsourcing, GeoCrowd, can be built on top of or incorporate MediaQ and can provide the mechanisms to support spatial tasks that are assigned and executed by human workers.

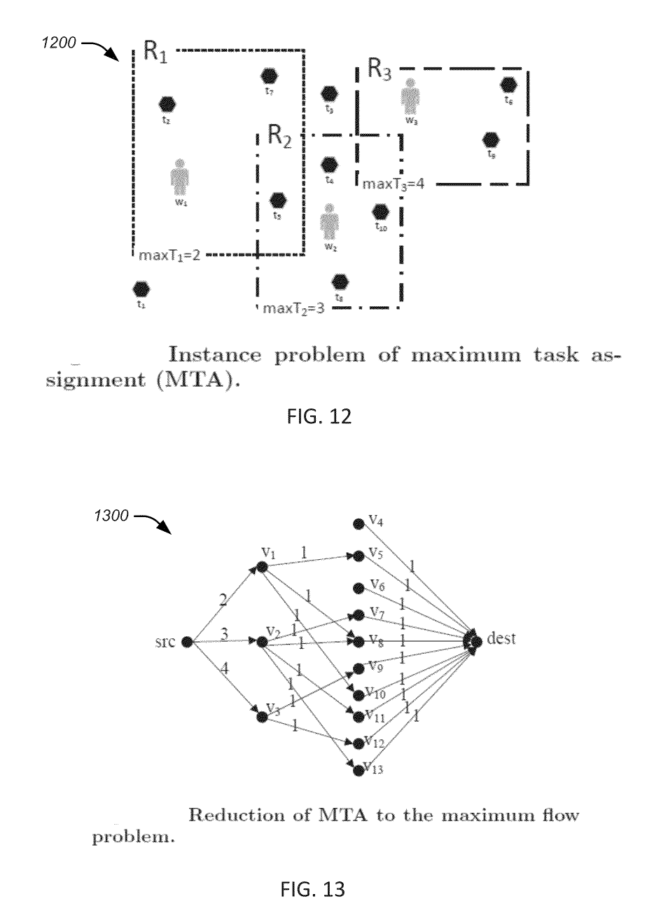

Requesters (e.g., users who are in need of labor to collect media content) can create spatial tasks and send them to the server. Each spatial task can be defined by a requester id i, its geo-location l, the start time s, the end time e, the number of videos to be crowdsourced k and the query q. A task can be represented by the tuple (i, l, s, e, k, q). Workers (users who are willing to collect media content for requesters) can send task inquiries (i.e., spatial regions of workers' interests) to the server. Each task inquiry is defined by a worker id i and two constraints: the spatial region where the worker can perform tasks R (rectangular region defined by SW, NE coordinates) and the maximum number of tasks maxT that the worker can execute. Task inquiries are represented by the tuple (i, R(SW, NE),maxT). The goal of the GeoCrowd algorithm is to assign as many tasks as possible to workers while respecting their constraints. For an example, an instance problem of the Maximum Task Assignment (MTA) is depicted in FIG. 12.

FIG. 12 shows a scenario 1200 having three workers (w₁ to w₃) along with their constraints, (maxT₁-maxT₃ and R₁-R₃) and the tasks (t₁-t₁₀). In this scenario 1200, it is clear that the tasks t₁ and t₃ are not possible to be assigned to any of the workers since they are outside of every spatial region R. In addition, worker w₁ can only accept tasks t₂, t₅ and t₇ but can perform only two of them because of the maxT₁ constraint.

As described above (e.g., for FIGS. 1-6), the MTA problem can be efficiently solved in polynomial time by reducing it to the maximum flow problem.

FIG. 13 shows how the above mentioned instance problem can be reduced to the maximum flow problem. Each worker and task are represented as vertices in a graph (v₁-v₃ for w₁-w₃ and v₄-v₁₃ for t₁-t₁₀). There is an edge between a worker and a task iff the task location is within the spatial region R of the worker. The edge capacity between workers and tasks is limited to 1, since it may be desirable that each a worker can perform a specific task once. Two new vertices are added, i.e., source (src) and destination (dest). There is an edge between the source node and each worker node with a weight equal to the maxT of the worker's constraint, thus restricting the flow and extend the number of assignments. Similarly, there is an edge between each task node to the destination node with a weight equal to K (the number of times that the task is going to be crowdsourced).

In FIG. 13, all weights are equal to 1 assuming that each task will be performed once. In the current algorithm implementation, the system is not restricted to K being equal to 1. After the graph construction any algorithm that solves the maximum flow problem can be used. In MediaQ, the well-established Ford-Fulkerson algorithm is implemented.

### GeoCrowd Architecture

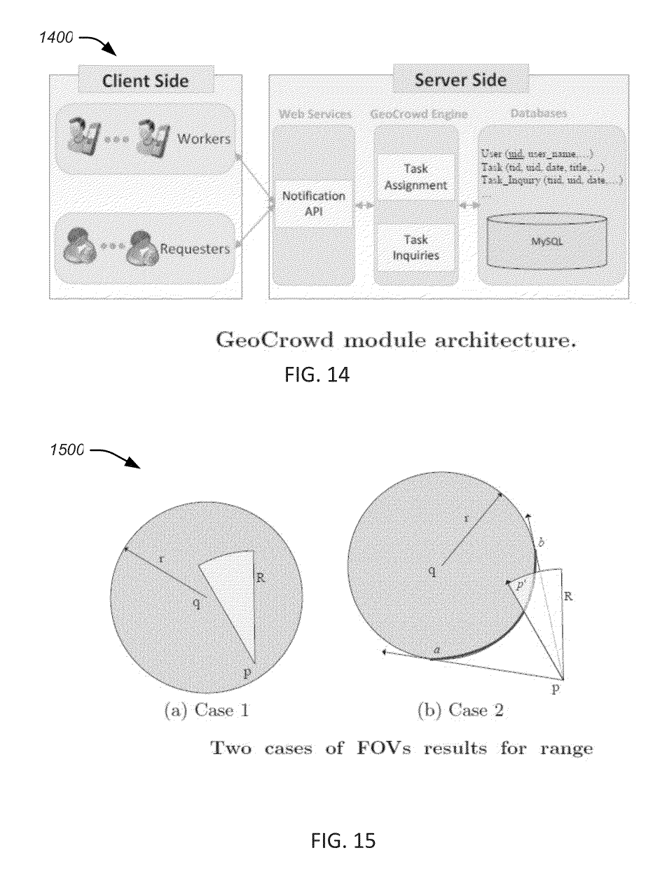

Using the above algorithm, GeoCrowd can be integrated into MediaQ (or vice versa). In addition to the description given above, an overview of the GeoCrowd module architecture 1400 is illustrated in FIG. 14. In order to support all necessary operations (e.g., task publishing, assignment processing, etc.), the GeoCrowd system can consist of two main components: 1) a smartphone app based on a mobile architecture, and 2) a server that manages all back- and front-end functionalities (i.e., web services, user management, task assignment, interfaces). The two main components are detailed below.

### GeoCrowd Web and DB Servers

GeoCrowd's back-end is deployed on the same server and shares the PHP CI framework with MediaQ. The server side mainly consists of:

FIG. 14: GeoCrowd module 1400 architecture
User Interfaces: Provides all interfaces to capture the user inputs that are needed to perform the task assignment process. Moreover, using the latest version of Google Maps JavaScript API V3 that provides a multi-functional map-based interface, MediaQ allows requesters to publish tasks. Specifically, requesters can setup the task details, which include Title, Description, Location, Expiry Date, Max K and media type to be captured. In addition, MediaQ supports interfaces to monitor tasks, view their status per requester and accept or decline a worker's response.
Web Services: Provides the connection between web and mobile interfaces to the database. The web services are built on top of a PHP CI framework which follows the Model-View-Controller (MVC) development pattern. GeoCrowd data (tasks, task inquiries, etc.) are posted to the appropriate controller and then it is decided which query to perform from the appropriate model. Data are safely stored in a MySQL database with spatial extensions for further processing. Spatial indices are created to support spatial queries performed by the Query Interface and to speed up the retrieval time.
Task Assignment Engine: In the current implementation, a controller is used as a cron job (a time-based job scheduler) to solve the MTA problem periodically. UNIX/Linux system crontab entries are used to schedule the execution of the MTA solver.
Notification API: The notification API uses Google Cloud Messaging (GCM) for Android to notify newly task-assigned workers in real-time.

### GeoCrowd Mobile Application

A MediaQ mobile application was implemented to support GeoCrowd operations. The GeoCrowd app runs on Android OS as a first step with a future view towards cross-platform compatibility. The app includes a map-based interface to enter and post workers' task inquiries and interfaces to check assigned tasks. The app capabilities are exploited to capture videos and metadata are extended to include worker ids, task ids and other related GeoCrowd information. Moreover, a push notification service (GCM mobile service) is running in the background to notify a worker in real-time when tasks are assigned to him/her by the GeoCrowd server.

### Query Processing

MediaQ can support region, range, directional, keyword queries and temporal queries. All the following queries are based on the metadata, e.g., as described herein.

### Region Queries

The query region in the described implementation implicitly uses the entire visible area on a map interface (i.e., Google Maps) as the rectangular region. The search engine retrieves all FOV's that overlap with the given visible rectangular region. The implementation of this kind of query aims to quickly show all the videos on the map without constraints.

### Range Queries

FIGS. 15A-B illustrate two cases of FOV's results for range queries in views 15A-15B. Range queries are defined by a given circle, within which all the FOV's are found that overlap with the area of the circle. The resulting FOV f(p, θ, R, α) of the range circle query (q, r) with the center point q and radius r fall into the following two cases:
Case 1: As shown in FIG. 15A, the camera location is within the query circle, i.e., the distance between the camera location p and the query location q is less than the query radius r of the query circle.
Case 2: As shown in FIG. 15B, although the camera location is outside of the query circle, the area of the FOV partially overlaps with the query circle. Specifically, line segment pp′ intersects with arc [symbol] , which is formulated in Eqn. 3, where β represents the angle between vector \vec{pq} and \vec{pp′}, and p′ denotes any point on the arc [symbol] of the FOV.

R≧Dist(p,q)×cos β−{square root over (r²−(Dist(p,q)×sin β)²)}Directional Queries

A directional query searches all video segments whose FOV direction angles are equal to or less than the range of an allowable error margin to a user-specified input direction angle. The videos to be searched are also restricted to their FOV's residing in the given range on the map inter-face. A user can initiate a directional query request through MediaQ GUI by defining the input direction angle which is an offset from the North. Then the directional query is automatically submitted to the server and the final query results, similar to those of other spatio-temporal queries, are rendered accordingly.

### Keyword Queries

Textual keywords can be automatically be attached to incoming video frames in MediaQ. The tagged keywords (i.e., “what” metadata) is related to the content of the videos. The textual keyword search provides an alternative and user-friendly way to search videos. In the MediaQ system, given a set of query keywords S, keyword queries are defined as finding all the video frames such that the associated keywords of each video frame contain all of the keywords in the query keyword set S. Keyword queries can be combined with region queries, range queries, and directional queries to provide richer query functions.

### Temporal Queries

Temporal queries are defined as “given a time interval, find all the video frames within the duration.” Note that the region queries, range queries, directional queries, and keyword queries described above can be combined with temporal queries, and they have been implemented in MediaQ.

### Presenting Query Results

The queries discussed so far can return resulting FOV's, i.e., discrete video frames, which is sufficient when searching images, but not for videos. Videos should be smoothly displayed for human perception. Hence, MediaQ presents the results of a video query as a continuous video segment (or segments) by grouping consecutive FOV's in the same video into a video segment. However, since mobile videos may be targeted, some cases may exist where the result consists of several segments within the same video. When the time gap between two adjacent segments of the same video is large, individual segment will be displayed independently. However, when the time gap is small it would be desirable to display the two adjacent segments as a single segment including the set of FOV's during the time gap (even though these FOV's are not really part of the result of the given query) for a better end-user viewing experience.

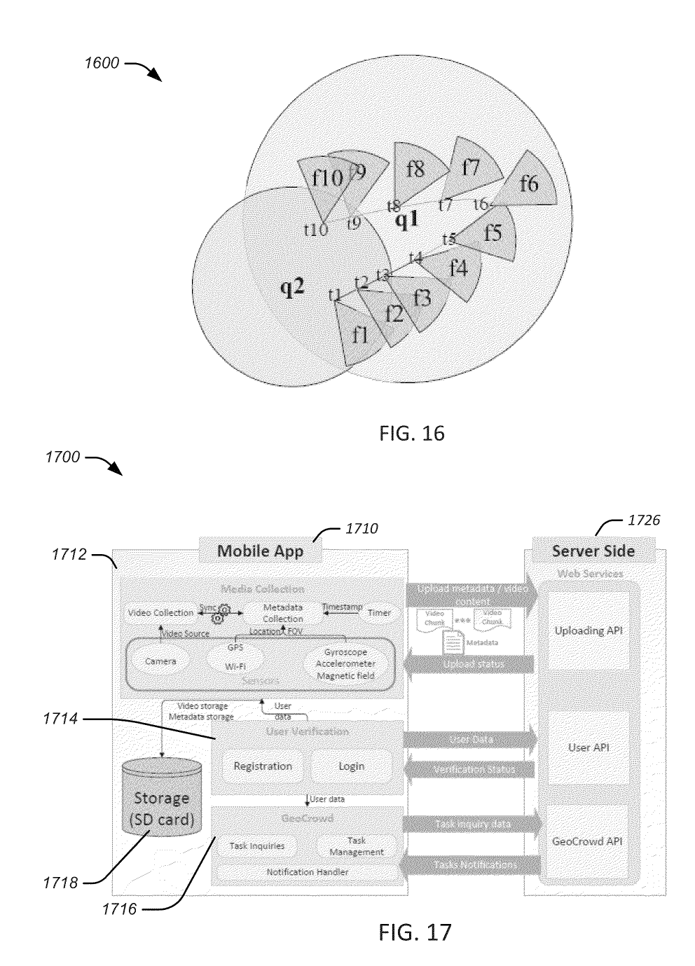

To achieve this, all the identified FOV's can be grouped by their corresponding videos and rank them based on their times-tamp values within each group. If two consecutively retrieved FOV's within the same group (e.g., in the same video) differ by more than a given time threshold (say, 5 seconds), the group can be divided into two separate video segments. FIG. 16 illustrates a query result representation through video segments. Circles q1 and q2 are two range query circles. Ten FOV's f1, . . . , f10 are part of the same video data, named V, with t1, . . . , d10 being their corresponding timestamps.

For example, in FIG. 16, if for the range query q1 all the frames f₁, . . . , f₁₀ are part of the query result, then the entire video V is returned and displayed as a single video. However, for query q2, two groups of video frames {f1, f2, f3}, and {f9, f10} represent the exact results. Then, there are two different ways to present the results: 1) when the time gap between t3 and t9 is more than the threshold time, 5 seconds, since f1, f2, f3 are continuous and part of the same video V, they can be combined together to generate a video segment result from t1 to t3. In the same way, query FOV results f9 and f10 are continuous so another video segment is generated from t9 to t10. Hence for query q2, two video segment results are returned, and 2) when the time gap between t3 and t9 is less than the threshold time, all frames can be combined to connect the two groups and present the result as one video, i.e., V.

### Panoramic Image Generation

Since MediaQ can provide the continuous fusion of geospatial metadata and video frames, such correlated information can be used for the generation of new visual information, not only for plain display of video results. This section describes an example of such an application, the automatic generation of panoramic images, to demonstrate the potential use of MediaQ for diverse video applications.

By providing an omnidirectional scene through one image, panoramic images have great potential to produce an immersive sensation and a new way of visual presentation. Panoramas are useful for a large number of applications such as in monitoring systems, virtual reality and image-based rendering. Thus, panoramic image generation can be considered from large-scale user-generated mobile videos for an arbitrary given location.

To generate good panoramas from a large set of videos efficiently, the following can be considered:
Acceleration of panorama stitching. Panorama stitching is time consuming because it involves a pipeline of complex algorithms for feature extraction, feature matching, image adjustment, image blending, etc.
Improving the quality of the generated panoramic images. Consecutive frames in a video typically have large visual overlap. Too much overlap between two adjacent video frames not only increases the unnecessary computational cost with redundant information, but also impacts blending effectiveness and thus reduces the panorama quality.

Embodiments of MediaQ can select the minimal number of key video frames from the videos based on their geographic metadata (e.g., locations and directions). Several novel key video frame selection methods have been proposed in prior work to effectively and automatically generate panoramic images from videos to achieve a high efficiency without sacrificing quality. The key video frame selection criteria of the introduced algorithms based on the geo-information are follows:
To select the video frames whose camera locations are as close as possible to the query location;
To select video frames such that every two spatially adjacent FOV's should have appropriate overlap since too much image overlap results in distortions and excessive processing for stitching while too little image overlap may result in stitching failure.
To select video frames whose corresponding FOV's cover the panoramic scene as much as possible.

### Social Networking

In addition to the basic functions of media content collection and management, MediaQ also provides the following social features: group sharing and region following of media contents.

### Group Sharing.

In MediaQ, users can join in multiple community groups (e.g., University of Southern California Chinese Students & Scholars Association (USC CSSA), USC CS). In a community group, users can share their media contents. In implemented embodiments of a MediaQ system, before uploading the recorded videos/images, users were allowed to select with which group(s) they wanted to share the videos/images. Three sharing options were provided: public, private, and group.

### Region Following.

Different from the person following and topic following in existing social network services such as Twitter, MediaQ proposes a new concept of “Region Following”, i.e., MediaQ users follow spatial regions. For example, a Chinese student studying in the U.S. may follow his/her hometown of Beijing as the following region. Then, any public media content covering the hometown will automatically be brought to the attention of the student immediately after it is uploaded.

### Mobile App

MediaQ functionality can be implemented in or with, and/or facilitated by a mobile app, which can be complementary component of MediaQ web system. The primary goal of the mobile app can be the collection of media contents accompanied with their metadata by exploiting all related mobile sensors, especially representing the spatial properties of videos.

FIG. 17 depicts an example of the design, or component arrangement 1700 of a MediaQ mobile app 1710 for use with a server side component 1720 such a GeoCrowd or GeoTruCrowd-based server. The design 1700 can include four main components for the app 1710, i.e., the media collection component 1712, the user verification component 1714, the GeoCrowd component 1716, and the storage component 1718. The media collection component 1712 is responsible for capturing video data and their metadata. Thus, while the user is recording a video, various sensors are enabled to collect data such as location data (from GPS) and FOV data (from digital compass). A timer can keep track of the recorded sensor data by relating each sensor record to a timestamp. The correlation of each record with a timestamp is extremely important because video frames must be synchronized with the sensed data. In addition, user data are added to the metadata and a JSON-formatted file is created.

The mobile app provides the interface to register and login to the MediaQ system, e.g., as shown in the server side component/system 1720. After login, users can use their device to record videos and upload them to the MediaQ server 1720. However, at times users may not have Internet access for login due to unavailable wireless coverage. In such cases users can still record a video and store it locally without logging into the system. Afterwards, when Internet access becomes available they can upload it to the server. The reason behind this is that every video belongs to a user and the server needs to know who the owner is. That may be achieved when the users are logged in to the system. After capturing a video, the mobile user is able to select which videos to upload, while others can remain in the device. Before uploading, the user can preview the recorded videos and their captured trajectories to ensure that each video's metadata are correct and the quality of the video is acceptable. As discussed above, GeoCrowd or GeoTruCrowd can be integrated into or with the MediaQ mobile app to support on-demand media collection. The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and advantages. These also include embodiments in which the components and/or steps are arranged and/or ordered differently.

For example, while certain exemplary assignment protocols are described above, others may be used within the scope of the present disclosure. Some examples include, but are not limited to: least-location entropy-based algorithms and nearest-neighbor priority algorithms, e.g., as described in the related incorporated provisional application 61/785,510, entitled “GeoCrowd—Next Generation of Data Collection: Harnessing the Power of Crowd for On-Demand Location Scouting,” filed Mar. 14, 2013.

Unless otherwise indicated, the servers, systems, and software modules that have been discussed herein are implemented with a computer system configured to perform the functions that have been described herein for the component. Each computer system includes one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Each computer system for the GeoCrowd and GeoTruCrowd systems/methods may be a desktop computer or a portable computer, such as a laptop computer, a notebook computer, a tablet computer, a PDA, a smartphone, or part of a larger system, such a vehicle, appliance, and/or telephone system.

A single computer system may be shared by various components/steps of the GeoCrowd and/or GeoTruCrowd implementations.

Each computer system for the GeoCrowd and GeoTruCrowd systems/methods may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer system, as recited herein. The description of each function that is performed by each computer system also constitutes a description of the algorithm(s) that performs that function.

The software may be stored on or in one or more non-transitory, tangible storage devices, such as one or more hard disk drives, CDs, DVDs, and/or flash memories. The software may be in any suitable programming language and may include source code and/or object code format and/or executable code. Associated data may be stored in any type of volatile and/or non-volatile memory. The software may be loaded into a non-transitory memory (e.g., computer-readable medium) and executed by one or more processors.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A computer-executable program product for spatial crowdsourcing, the computer-executable program product comprising a non-transitory computer-readable medium with resident computer-readable instructions, the computer readable instructions comprising instructions for:
receiving one or more queries for one or more spatial tasks associated with a location; assigning one or more of the tasks to one or more workers from a plurality of workers available at the location; and
receiving task results from one or more workers.

2. The computer-executable program product of claim 1, wherein assigning one or more of the tasks comprises solving a maximum task assignment problem (MTA).

3. The computer-executable program product of claim 1, wherein assigning one or more of the tasks comprises solving a maximum correct task assignment problem (MCTA).

4. The computer-executable program product of claim 3, wherein a query comprises a probabilistic spatial crowdsourced query specifying a spatial task t that is α-confident, wherein task t is α-confident when the probability of the task t being performed correctly is greater than or equal to a confidence threshold α.

5. The computer-executable program product of claim 4, wherein the probabilistic crowdsourced query comprises a set of tuples of form <tᵢ,αᵢ> issued by a requestor, wherein every spatial task tᵢ is to be crowdsourced with at least αᵢ confidence.

6. The computer-executable program product of claim 4, further comprising associating a reputation score with each worker, wherein the reputation score represents a probability that the worker will perform a task correctly.

7. The computer-executable program product of claim 6, further comprising assigning the task to a subset of multiple workers in the event that no single worker available at the location has a reputation score sufficient by itself to insure that the single worker can complete the assigned spatial task.

8. The computer-executable program product of claim 7, further comprising using a voting mechanism to aggregate the reputation scores of the workers.

9. The computer-executable program product of claim 8, wherein the voting mechanism includes computing the probability that the majority of workers of the subset will perform the assigned task correctly.

10. The computer-executable program product of claim 8, wherein an aggregate reputation score is calculated according to:
$$A R S ( Q ) = {\sum }_{k = \frac{\vert Q \vert}{2} + 1}^{\vert Q \vert} {\sum }_{A ⋐ Fk} {\prod }_{{w}_{2} ∈ A} {r}_{j} {\prod }_{{w}_{3} ∉ A} ( 1 - {r}_{j} )$$
where Fₖ is all the subsets of Q with size k, and rⱼ is the reputation of the worker wⱼ.

11. The computer-executable program product of claim 3, wherein the step of assigning the task to a plurality of workers at the location comprises a maximum correct task assignment (MCTA) implementing an approximation algorithm that solves the 3D-macthing problem for the one or more spatial tasks and available number of workers at the location.

12. The computer-executable program product of claim 11, wherein the approximation algorithm comprises a greedy algorithm.

13. The computer-executable program product of claim 11, wherein the approximation algorithm comprises a local optimization algorithm.

14. The computer-executable program product of claim 11, wherein the approximation algorithm comprises a heuristic-based greedy algorithm.

15. The computer-executable program product of claim 14, wherein the heuristic-based greedy algorithm implements a filtering heuristic.

16. The computer-executable program product of claim 14, wherein the heuristic-based greedy algorithm implements a least worker assigned (LWA) heuristic.

17. The computer-executable program product of claim 14, wherein the heuristic-based greedy algorithm implements a least aggregate distance (LAD) heuristic.

18. The computer-executable program product of claim 11, wherein the approximation algorithm computes a potential match for each spatial task.

19. The computer-executable program product of claim 18, wherein the approximation algorithm computes the aggregate reputation score for each combination of workers whose spatial regions contain a given task t.

20. The computer-executable program product of claim 19, further comprising pruning from the number of correct matches those that do not contribute to the final result.

21. The computer-executable program product of claim 20, wherein pruning comprises removing correct matches that are dominated by other correct matches.

22. The computer-executable program product of claim 1, wherein the step of receiving task results from the one or more workers includes receiving data from a mobile device.

23. A computer-executable program product for spatial crowdsourcing, the computer-executable program product comprising a non-transitory computer-readable medium with resident computer-readable instructions, the computer readable instructions comprising instructions for:
receiving one or more queries for one or more spatial tasks associated with a location, wherein each query comprises a probabilistic spatial crowdsourced query specifying a spatial task t that is α-confident, wherein task t is α-confident when the probability of the task t being performed correctly is greater than or equal to a confidence threshold α;
assigning one or more of the tasks to one or more workers from a plurality of workers available at the location;
associating a reputation score with each worker, wherein the reputation score represents a probability that the worker will perform a task correctly; and
receiving task results from one or more workers.

24. The computer-executable program product of claim 23, wherein the reputation score of a worker is 1.0.

25. The computer-executable program product of claim 23, wherein α=0.
